(19) United States
(12) Patent Application Publication
(10) Pub. No.: US 2015/0160162 A1
(43) Pub. Date: Jun. 11, 2015

(54) USER INTERFACES, SYSTEMS AND METHODS FOR DISPLAYING MULTI-DIMENSIONAL DATA FOR ION MOBILITY SPECTROMETRY-MASS SPECTROMETRY

(71) Applicant: Agilent Technologies, Inc., Santa Clara, CA (US)

(72) Inventors: Edward Darland, Santa Clara, CA (US); Robin A. Scheiderer, Santa Clara, CA (US); Robert Kincaid, Santa Clara, CA (US)

(21) Appl. No.: 14/549,274

(22) Filed: Nov. 20, 2014

Related U.S. Application Data
(60) Provisional application No. 61/914,621, filed on Dec. 11, 2013.

(51) Int. Cl. G01N 27/62

(52) U.S. Cl. CPC G01N 27/622

(57) ABSTRACT

A user interface, and related systems and methods, are provided for displaying multi-dimensional spectrometric data obtained from IMS-MS operations. The user interface displays such data in alternative data plots, such as drift spectra, mass spectra, and multi-dimensional maps. Different plots may be dynamically linked to each other, enabling a user to select a data range or ranges in one plot and consequently cause other plots to be updated, changed, or replaced, or new plots to be extracted or generated, in accordance with the selected data range or ranges.

### RELATED APPLICATIONS

This application claims the benefit of U.S. Provisional Patent Application Ser. No. 61/914,621, filed Dec. 11, 2013, titled “USER INTERFACES, SYSTEMS AND METHODS FOR DISPLAYING MULTI-DIMENSIONAL DATA FOR ION MOBILITY SPECTROMETRY-MASS SPECTROMETRY,” the content of which is incorporated by reference herein in its entirety.

### TECHNICAL FIELD

The present invention relates generally to ion mobility spectrometry-mass spectrometry (IMS-MS), and more specifically to user interfaces and related systems and methods for displaying multi-dimensional spectrometric data obtained from IMS-MS operations.

### BACKGROUND

A mass spectrometry (MS) system in general includes an ion source for ionizing components of a sample of interest, a mass analyzer for separating the ions based on their differing mass-to-charge ratios (or m/z ratios, or more simply “masses”), an ion detector for counting the separated ions, and electronics for processing output signals from the ion detector as needed to produce a user-interpretable mass spectrum. Typically, the mass spectrum is a series of peaks indicative of the relative abundances of detected ions as a function of their m/z ratios. The mass spectrum may be utilized to determine the molecular structures of components of the sample, thereby enabling the sample to be qualitatively and quantitatively characterized. One popular type of MS is the time-of-flight mass spectrometer (TOF MS). A TOF MS utilizes a high-resolution mass analyzer (TOF analyzer). Ions may be transported from the ion source into the TOF entrance region through a series of ion guides and ion lenses. The TOF analyzer includes an ion extractor (or pulser) that extracts ions in pulses (or packets) into an electric field-free flight tube. In the flight tube, ions of differing masses travel at different velocities and thus separate (spread out) according to their differing masses, enabling mass resolution based on time-of-flight.

Ion mobility spectrometry (IMS) is a fast gas-phase ion separation technique in which ions travel a known distance through a drift cell in an environment of a known gas pressure and composition. The ions are produced from a sample in an ion source and travel through the drift cell under the influence of a DC voltage gradient. During this travel, the ions become separated based on their different collision cross-sections, which can be correlated to their differing mobilities through the drift gas. From the drift cell the ions arrive at an ion detector that counts the separated ions, enabling the production of peak information useful for distinguishing among the different analyte ion species detected. An IMS system may be coupled online with an MS, particularly a TOF MS. In the combined IMS-MS system, ions are separated by mobility prior to being transmitted into the MS where they are then mass-resolved. Performing the two separation techniques in tandem is particularly useful in the analysis of complex chemical mixtures, including biopolymers such as polynucleotides, proteins, carbohydrates and the like, as the added dimension provided by the IM separation may help to separate ions that are different from each other but present overlapping mass peaks. This hybrid separation technique may be further enhanced by coupling it with liquid chromatography (LC) or gas chromatography (GC) techniques.

The data acquired from processing a sample through an IMS-MS system may be multi-dimensional, typically including ion abundance, acquisition time (or retention time), ion drift time through the IMS drift cell, and m/z ratio as sorted by the MS. The multi-dimensional data may be complex and difficult to interpret and manipulate by a researcher or user of the IMS-MS system. Conventional user interfaces utilized to display multi-dimensional spectrometric data provide less than satisfactory solutions to aiding in the comprehension and manipulation of such data.

Therefore, there is a need for providing improved user interfaces and related systems and methods for displaying multi-dimensional spectrometric data obtained from IMS-MS operations.

### SUMMARY

To address the foregoing problems, in whole or in part, and/or other problems that may have been observed by persons skilled in the art, the present disclosure provides methods, processes, systems, apparatus, instruments, and/or devices, as described by way of example in implementations set forth below.

According to one embodiment, a method for displaying and navigating multi-dimensional spectrometric data includes: receiving ion mobility drift spectral data and mass spectral data; in a display comprising a plurality of regions, displaying in a first region a first ion data plot of abundance versus first data; displaying, in a second region of the display, a second ion data plot of abundance versus second data, wherein the second data are a dimension of data different from the first data; receiving a user selection of a data range of data currently displayed in a selected region of the display, wherein the selected region is at least one of the first region, the second region, and a region of the display other than the first region and the second region; and in response to the user selection, displaying a third ion data plot of abundance versus third data in at least one of the regions of the display, wherein the third data spans a data range corresponding to the selected data range.

According to another embodiment, an ion mobility spectrometry-mass spectrometry (IMS-MS) system includes at least a processor and a memory configured for performing all or part of any of the methods disclosed herein.

According to another embodiment, an ion mobility spectrometry-mass spectrometry (IMS-MS) system includes: a computing device; and an ion detector communicating with the computing device, wherein the IMS-MS system is configured for performing all or part of any of the methods disclosed herein.

According to another embodiment, a computer-readable storage medium includes instructions for performing all or part of any of the methods disclosed herein.

According to another embodiment, a system includes the computer-readable storage medium.

Other devices, apparatus, systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims.

### BRIEF DESCRIPTION OF THE DRAWINGS

The invention can be better understood by referring to the following figures. The components in the figures are not necessarily to scale, emphasis instead being placed upon illustrating the principles of the invention. In the figures, like reference numerals designate corresponding parts throughout the different views.

FIG. 1A is a schematic view of an example of an ion mobility spectrometry-mass spectrometry (IMS-MS) system according to some embodiments, and which may be utilized in the implementation of the subject matter described herein.

FIG. 1B is a schematic view of an example of a computing device that may be part of or communicate with the IMS-MS system illustrated in FIG. 1A.

FIG. 2 is an example of a screen display provided as part of a user interface.

FIG. 3A is an example of a first display area of the screen display, which includes an unfiltered total ion (current) chromatogram (TIC), in which the summed value of total ion signal (current) intensity (y-axis) is plotted as a function of the acquisition time (x-axis).

FIG. 3B is an example of a first display area of the screen display, which includes an extracted ion (current) chromatogram (EIC) filtered based on a selected mass range.

FIG. 3C is an example of a first display area of the screen display, which includes an EIC filtered based on both a selected mass range and a selected drift range.

FIG. 4 is an example of the first display area that includes a “frame selector” view.

FIG. 5 is an example of the first display area that includes an ion measurement graph that provides an overview of the overall sample analysis.

FIG. 6A is an example of the first display area that includes an overall chromatogram spanning the full duration of a sample analysis.

FIG. 6B is an example of the first display area that includes a chromatogram that results after selecting an acquisition time range originally part of the full range displayed in FIG. 6A.

FIG. 6C is an example of the first display area that includes a heat map plotting ion abundance versus drift time versus acquisition time, where the acquisition time visible is limited to the range previously selected in conjunction with FIG. 6C.

FIG. 7A is an example of the first display area that includes a chromatogram, in which an acquisition time range has been selected and a context menu has been invoked.

FIG. 7B is an example of the first display area that includes an overall heat map corresponding to the chromatogram illustrated in FIG. 7A.

FIG. 8 is an example of a second display area of the screen display, which includes multiple display regions.

FIG. 9 is an example of the second display area displaying the same frame of data as that illustrated in FIG. 8, but zoomed in to a narrower drift time range and m/z range.

FIG. 10 is an example of the second display area displaying the same graphs as that illustrated in FIG. 9, illustrating an example of selecting a range of data.

FIG. 11 is an example of the second display area displaying the same graphs as that illustrated in FIGS. 9 and 10, illustrating an example of selecting ranges of two types of data.

FIG. 12A is an example of the second display area in which a custom drift spectrum has been generated based an m/z range selected in the dynamic mass spectrum.

FIG. 12B is an example of the second display area in which a different custom drift spectrum has been generated based on selection of a different m/z range as compared to FIG. 12A.

FIG. 12C is an example of the second display area in which a custom mass spectrum has been generated based on a drift time range selected in the dynamic drift spectrum.

FIG. 12D is an example of the second display area, illustrating an example of selecting ranges of two types of data to generate corresponding custom spectra.

FIG. 13 is an example of the screen display, illustrating an example of the first display area and the second display area.

FIG. 14A is an example of a third display area of the screen display, which includes a custom spectra region.

FIG. 14B is another example of the third display area, which includes a custom spectra region displaying custom spectra in a different arrangement as compared to FIG. 14A.

FIG. 15 is another example of the third display area, which includes a collisional cross-section calculator region, and an example of a fourth display area of the screen display, which includes a cross section plot region.

FIG. 16A is an example of the screen display, illustrating selection of an ion for cross-section calculation.

FIG. 16B is an example of the screen display, displaying data resulting from the cross-section calculation.

FIG. 16C is an example of the screen display similar to FIG. 16B, after executing a command to display source data utilized in performing the cross-section calculation.

### DETAILED DESCRIPTION

As used herein, an “ion data plot” or “ion measurement graph” may refer to any visual representation of data that plots ion abundance and one or more other dimensions pertaining to ion measurement. Examples of an “ion data plot” or “ion measurement graph” include, but are not limited to, a chromatogram plotting abundance versus acquisition time; a drift spectrum plotting abundance versus drift time; a mass spectrum plotting abundance versus m/z ratio; a map plotting abundance versus drift time versus acquisition time; a map plotting abundance versus m/z ratio versus acquisition time; and a map plotting abundance versus drift time versus m/z ratio

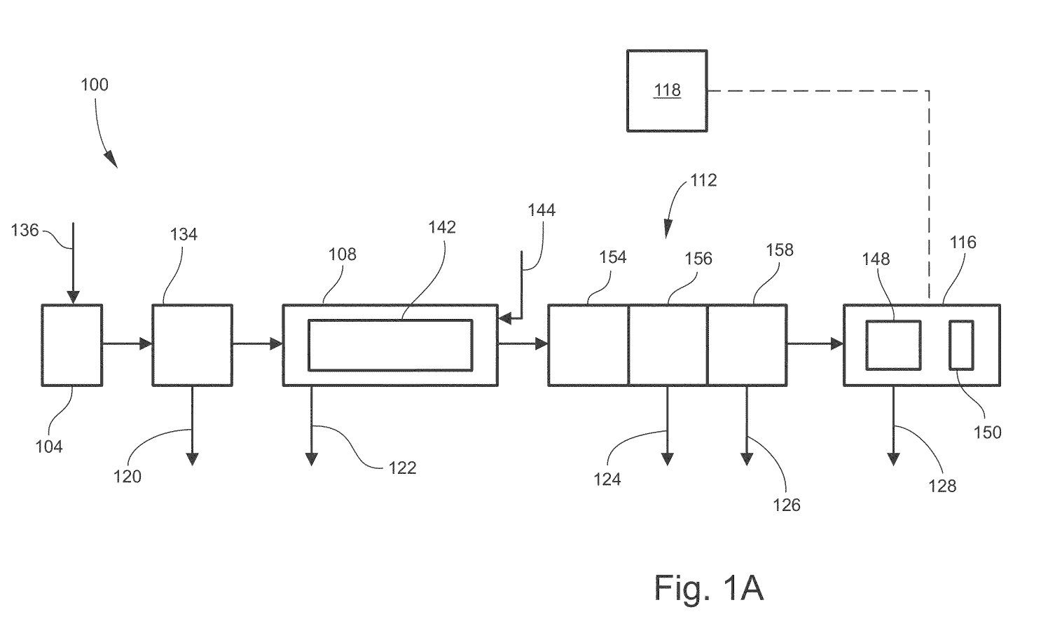

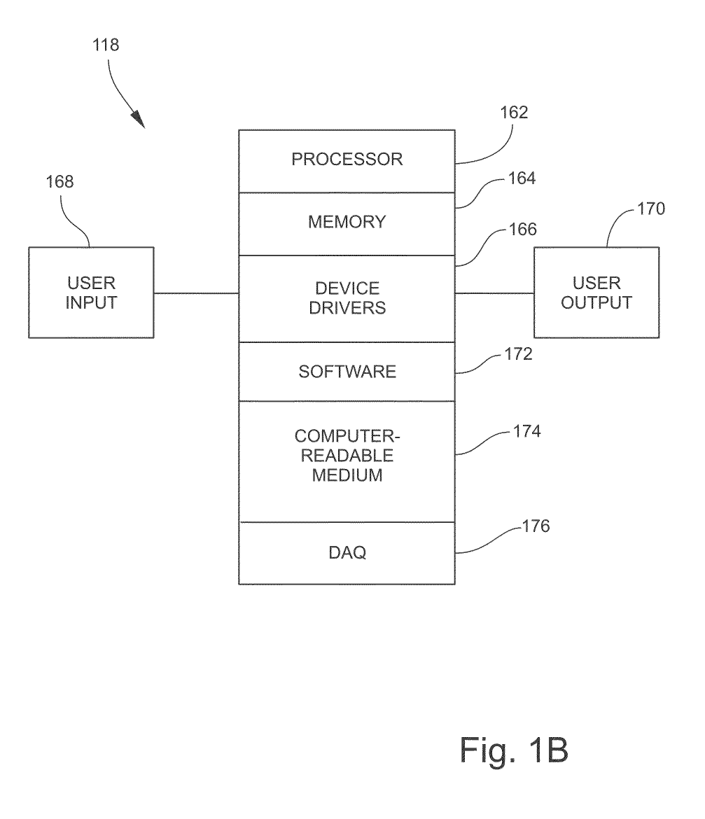

FIG. 1A is a schematic view of an example of an ion mobility spectrometry-mass spectrometry (IMS-MS) system 100 according to some embodiments, and which may be utilized in the implementation of the subject matter described herein. In various embodiments, the IMS-MS system 100 may include, or be part of, or communicate with a system for displaying multi-dimensional spectrometric data as described below.

The IMS-MS system 100 generally includes an ion source 104, an IMS 108, and an MS 116. The IMS-MS system 100 may also include an IMS-MS interface 112 between the IMS 108 and the MS 116 for one or more purposes such as pressure reduction, neutral gas removal, ion focusing, etc. The IMS-MS system 100 may also include an ion trap and/or ion gate 134 between the ion source 104 and the IMS 108. In some embodiments in which the ion source 104 is configured for outputting pulses or packets of ions, the ion trap and/or ion gate 134 may not be included. The IMS-MS system 100 also includes vacuum system for maintaining various interior regions of the IMS-MS system 100 at controlled, sub-atmospheric pressure levels. The vacuum system is schematically depicted by vacuum lines 120-128. The vacuum lines 120-128 are schematically representative of one or more vacuum-generating pumps and associated plumbing and other components appreciated by persons skilled in the art. The vacuum lines 120-128 may also remove any residual non-analytical neutral molecules from the ion path through the IMS-MS system 100. The IMS-MS system 100 also includes a computing device 118 for providing and controlling a user interface as described below, and for controlling various components of the IMS-MS system 100. The operation and design of various components of IMS-MS systems are generally known to persons skilled in the art and thus need not be described in detail herein. Instead, certain components are briefly described to facilitate an understanding of the subject matter presently disclosed.

The ion source 104 may be any type of continuous-beam or pulsed ion source suitable for producing analyte ions for spectrometry. Examples of ion sources 104 include, but are not limited to, electrospray ionization (ESI) sources, other atmospheric pressure ionization (API) sources, photo-ionization (PI) sources, electron ionization (EI) sources, chemical ionization (CI) sources, field ionization (FI) sources, plasma or corona discharge sources, laser desorption ionization (LDI) sources, and matrix-assisted laser desorption ionization (MALDI) sources. In some embodiments, the ion source 104 may include two or more ionization devices, which may be of the same type or different type. Depending on the type of ionization implemented, the ion source 104 may reside in a vacuum chamber or may operate at or near atmospheric pressure. Sample material to be analyzed may be introduced to the ion source 104 by any suitable means, including hyphenated techniques in which the sample material is an output 136 of an analytical separation instrument such as, for example, a gas chromatography (GC) or liquid chromatography (LC) instrument (not shown).

The IMS 108 includes a drift cell 142 enclosed in a chamber. The chamber communicates with a pump that maintains the drift cell 142 at a drift gas pressure ranging from, for example, 1 to 10 Torr. A gas inlet 144 directs an inert drift gas (e.g., nitrogen) into the drift cell 142 chamber. The drift cell 142 includes a series of drift cell electrodes (typically ring-shaped) spaced along the axis. The drift cell electrodes are in signal communication with a voltage source to generate a DC voltage gradient along the axis. The axial DC voltage gradient moves the ions through the drift cell 142 in the presence of the drift gas, whereby the ions become separated in time based on their different cross-sections as appreciated by persons skilled in the art. The DC voltage gradient may be generated in a known manner, such as by applying a voltage between the first and last drift cell electrodes, and through a resistive divider network between the first and last drift cell electrodes, such that successively lower voltages are applied to the respective drift cell electrodes along the length of the drift cell 142.

The IMS-MS interface 112 is configured for receiving the ions eluting from the drift cell 142 and transferring the ions to the MS 116 (or to intervening components between the drift cell 142 and the MS 116). The IMS-MS interface 112 includes a housing that may include one or more chambers 154, 156, and 158 which may serve as pressure-reducing transitions between the IMS 142 and the MS 116. Each chamber may be fluidly isolated from the other chambers and provide an independently controlled pressure stage, while appropriately sized apertures are provided at the boundaries between adjacent chambers to define a pathway for ions to travel through the IMS-MS interface 112 from one chamber to the next chamber. The IMS-MS interface 112 may also include one or more ion guides enclosed in the respective chambers. In any given chamber, the ion guide may be a linear multipole ion guide (typically, but not limited to, hexapole and octopole), an ion funnel, or electrostatic lens. Multipole ion guides and ion funnels may apply radio frequency (RF) and/or direct current (DC) voltages to control ion motion in a manner appreciated by persons skilled in the art. Ion optics (not shown) may be provided between adjacent ion guides, and may form a part of the boundary between adjacent chambers.

The MS 116 may generally include a mass analyzer 148 and an ion detector 150 enclosed in a chamber. The vacuum line 128 maintains the interior of the mass analyzer 148 at very low (vacuum) pressure. In some embodiments, the mass analyzer 148 pressure ranges from 10⁻⁴ to 10⁻⁹ Torr. The mass analyzer 148 may be any device configured for separating, sorting or filtering analyte ions on the basis of their respective m/z ratios. Examples of mass analyzers include, but are not limited to, multipole electrode structures (e.g., quadrupole mass filters, ion traps, etc.), time-of-flight (TOF) analyzers, ion cyclotron resonance (ICR) traps, and electric field or magnetic field based sector instruments. The mass analyzer 148 may include a system of more than one mass analyzer, particularly when ion fragmentation analysis is desired. As examples, the mass analyzer 148 may be a tandem MS or MS' system, as appreciated by persons skilled in the art. As another example, the mass analyzer 148 may include a mass filter followed by a collision cell, which in turn is followed by a mass filter (e.g., a triple-quad or QQQ system) or a TOF analyzer (e.g., a qTOF system). The ion detector 150 may be any device configured for collecting and measuring the flux (or current) of mass-discriminated ions outputted from the mass analyzer 148. Examples of ion detectors 150 include, but are not limited to, multi-channel plates, electron multipliers, photomultipliers, and Faraday cups.

The computing device 118 is schematically depicted as representing one or more modules or components configured for controlling, monitoring and/or timing various functional aspects of the IMS-MS system 100 such as, for example, the ion source 104, the IMS 108, and the MS 116, as well as any vacuum pumps, ion optics, upstream LC or GC instrument, sample introduction device, etc., that may be provided in the IMS-MS system 100 but not specifically shown in FIG. 1A. One or more modules or components may be, or be embodied in, for example, a desktop computer, laptop computer, portable computer, tablet computer, handheld computer, mobile computing device, personal digital assistant (PDA), smartphone, etc. The computing device 118 may also schematically represent all voltage sources not specifically shown, as well as timing controllers, clocks, frequency/waveform generators and the like as needed for applying voltages to various components of the IMS-MS system 100. The computing device 118 may also be configured for receiving the ion detection signals from the ion detector 128 and performing tasks relating to data acquisition and signal analysis as necessary to generate chromatograms, drift spectra, and mass spectra characterizing the sample under analysis. The computing device 118 may also be configured for providing and controlling a user interface that provides screen displays of spectrometric data and other data with which a user may interact, as described below. The computing device 118 may include one or more reading devices on or in which a tangible computer-readable (machine-readable) medium may be loaded that includes instructions for performing all or part of any of the methods disclosed herein. For all such purposes, the computing device 118 may be in signal communication with various components of the IMS-MS system 100 via wired or wireless communication links (as partially represented, for example, by a dashed line between the computing device 118 and the MS 116). Also for these purposes, the computing device 118 may include one or more types of hardware, firmware and/or software, as well as one or more memories and databases.

FIG. 1B is a schematic view of a non-limiting example of a computing device 118 that may be part of or communicate with an IMS-MS system such as that illustrated in FIG. 1A. In the illustrated embodiment the computing device 118 includes a processor 162 (typically electronics-based), which may be representative of a main electronic processor providing overall control, and one or more electronic processors configured for dedicated control operations or specific signal processing tasks (e.g., a graphics processing unit, or GPU). The computing device 118 also includes one or more memories 164 (volatile and/or non-volatile) for storing data and/or software. The computing device 118 may also include one or more device drivers 166 for controlling one or more types of user interface devices and providing an interface between the user interface devices and components of the computing device 118 communicating with the user interface devices. Such user interface devices may include user input devices 168 (e.g., keyboard, keypad, touch screen, mouse, joystick, trackball, and the like) and user output devices 170 (e.g., display screen, printer, visual indicators or alerts, audible indicators or alerts, and the like). In various embodiments, the computing device 118 may be considered as including one or more user input devices 168 and user output devices 170, or at least communicating with them. The computing device 118 may also include one or more types of computer programs or software 172 contained in memory and/or on one or more types of computer-readable media 174. Computer programs or software may contain instructions (e.g., logic instructions) for performing all or part of any of the methods disclosed herein. Computer programs or software may include application software and system software. System software may include an operating system (e.g., a Microsoft Windows® operating system) for controlling and managing various functions of the computing device 118, including interaction between hardware and application software. In particular, the operating system may provide a graphical user interface (GUI) displayable via a user output device 170 such as a display screen, and with which a user may interact with the use of a user input device 168 such as a keyboard or a pointing device (e.g., mouse). The computing device 118 may also include one or more data acquisition/signal conditioning components 176 (as may be embodied in hardware, firmware and/or software) for receiving and processing ion measurement signals outputted by the ion detector 150, including formatting data for presentation in graphical form by the GUI.

It will be understood that FIGS. 1A and 1B are high-level schematic depictions of an example of an IMS-MS system 100 and associated computing device 118 consistent with the present disclosure. Other components, such as additional structures, vacuum pumps, gas plumbing, ion optics, ion guides, electronics, and computer- or electronic processor-related components may be included as needed for practical implementations. It will also be understood that the computing device 118 is schematically represented in FIG. 1B as functional blocks intended to represent structures (e.g., circuitries, mechanisms, hardware, firmware, software, etc.) that may be provided. The various functional blocks and signal links have been arbitrarily located for purposes of illustration only and are not limiting in any manner. Persons skilled in the art will appreciate that, in practice, the functions of the computing device 118 may be implemented in a variety of ways and not necessarily in the exact manner illustrated in FIGS. 1A and 1B and described herein.

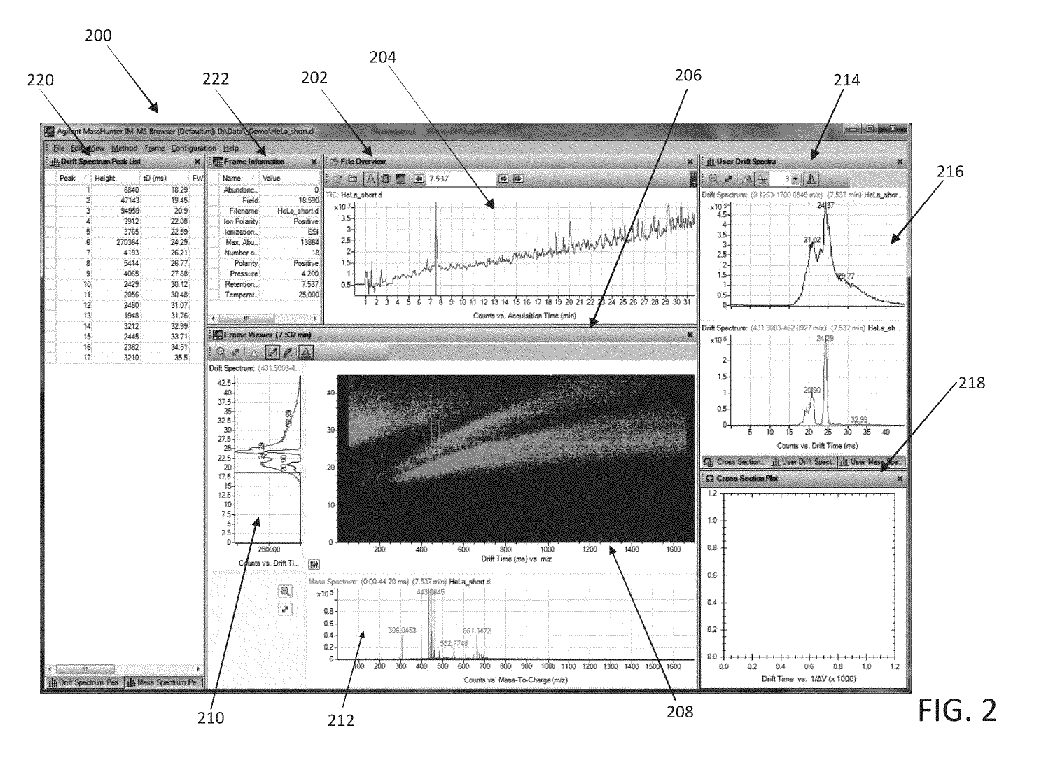

FIG. 2 is an example of a screen display 200 that may be provided as part of a user interface (e.g., a GUI). The screen display 200 includes (displays) an example of a graphical representation of data acquired by an IMS-MS system during analysis of a sample. The screen display 200 may be presented to a user, for example, on a user output device (e.g., a display screen) controlled by a computing device, such as the computing device 118 of the IMS-MS system 100 described above and illustrated in FIGS. 1A and 1B.

The screen display 200 may include a plurality of different display regions (or “panes”), each including different types of information (data) pertaining to the IMS-MS system and/or the sample analysis performed thereby. The screen display 200 may be, or be part of, a GUI controlled by software such as, for example, Microsoft Windows® software and by application software specifically configured for implementing subject matter disclosed herein. The screen display 200 may be a display area (or window), or may include a plurality of display areas (or windows). The display areas or windows may be of the type known to users of Microsoft Windows® software or persons skilled in the art. As appreciated by persons skilled in the art, such display areas or windows may be manipulated in a variety of ways, often with the use of a pointing device such as a mouse. As examples, display areas or windows may be moved to different locations on a display screen, scaled to be displayed larger or smaller on the display screen, minimized to a bar on the display screen, maximized so as to occupy all or the majority of the display screen, restored to a previously set size and/or location on the display screen, closed so as to be removed from the screen display 200, opened so as to be displayed on the screen display 200, etc. In some embodiments, a selected display area or window may be moved to a location on the computing device's display screen that is outside the screen display 200 illustrated in FIG. 2. As used herein, the term “display screen” may encompass more than one physical display screen, for example two or more monitors. Thus, in some embodiments the screen display 200 may occupy more than one physical display screen. Additionally, individual display areas or windows may be moved from one physical display screen to another or opened in any physical display screen available to the user.

A given display area or window may include one or more display regions or panes. Two or more display regions or panes, within the same display area or window or in different display areas or windows, may be dynamically linked as described below.

In the example illustrated in FIG. 2, the screen display 200 includes a first display area 202 (labeled File Overview) including (displaying) an acquisition time region 204, and a second display area 206 (labeled Frame Viewer) including (displaying) a first region (e.g., a map region) 208, a second region (e.g., a drift spectrum region) 210, and a third region 212 (e.g., a mass spectrum region) Also in this example, the display screen includes additional display areas, specifically a third display area 214 (labeled User Drift Spectra) including a custom spectra region 216, a fourth display area 218 (labeled Cross Section Plot), a fifth display area 220 (labeled Drift Spectrum Peak List), and a sixth display area 222 (labeled Frame Information). Some display regions (or some display areas) may be swapped with other display regions (or display areas) for display at the same location on the display screen, such as by using a pointing device to click on a tab that presents a label indicative of the type of display region (or display area) associated therewith. In the illustrated example, the User Drift Spectra may be swapped with User Mass Spectra or with a Cross Section Calculator for display in the third display area 214, and the Drift Spectrum Peak List may be swapped with a Mass Spectrum Peak List for display in the fifth display area 220. Moreover, the content displayed in a given display area (or in a display region of the display area), or a portion of the content (e.g., a certain type of information or data being displayed), may be changed by selecting a command. Such a command may be made available on the display screen, such as from a list provided in a drop-down menu, a context menu, or the like, or on a selectable tab, button, etc.

The first display area 202 and second display area 206 provide four-dimensional (4D) data (abundance versus acquisition time versus drift time versus m/z ratio) acquired from the sample analysis performed by the IMS-MS system. The regions displayed in the first display area 202 and second display area 206 are configured for aiding visualization of the 4D data by showing a set of two-dimensional (2D) or pseudo-three-dimensional (pseudo-3D) “slices” or “projections” of the 4D data, which a user can more easily comprehend. As described in more detail below, one or more regions displayed in the first display area 202 and second display area 206 may be dynamically linked to one or more other regions displayed in the first display area 202 and second display area 206. In some embodiments, each region displayed in the first display area 202 and second display area 206 is dynamically linked to each of the other regions displayed in the first display area 202 and second display area 206. In the present context, “dynamically linked” means that if a change is made in the display of selected data in one region, a corresponding change is dynamically (or automatically) made in the display of corresponding data in one or more other regions that display the corresponding data (and which are dynamically linked to the selected region). For example, a change made in the range over which selected data (e.g., drift time data) is displayed in a selected region will also change the range over which corresponding data (e.g., drift time data) is displayed in one or more other regions that also display such data. Such actions may be initiated by the user, as described below.

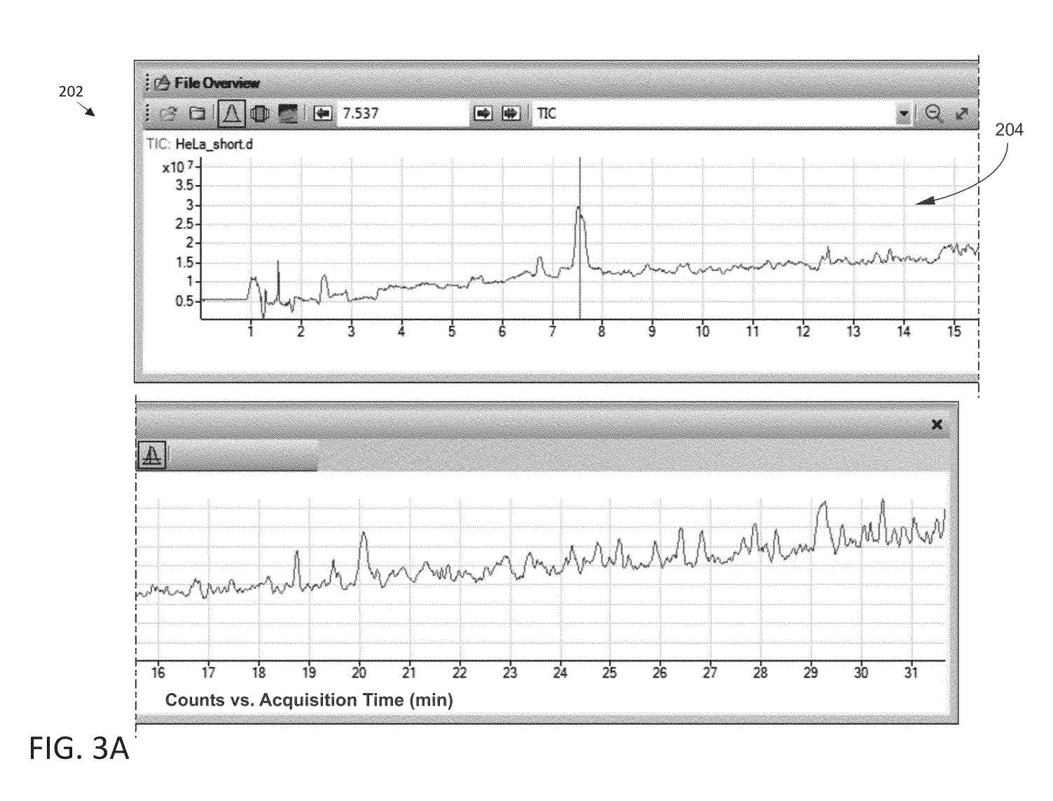

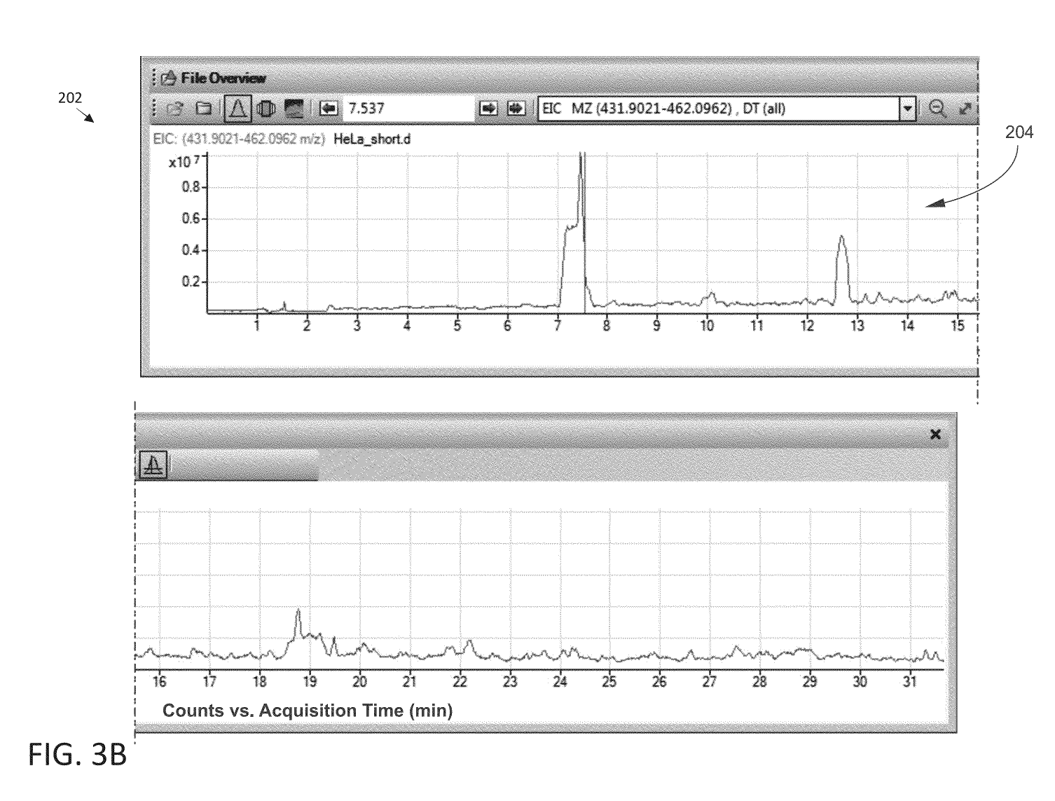

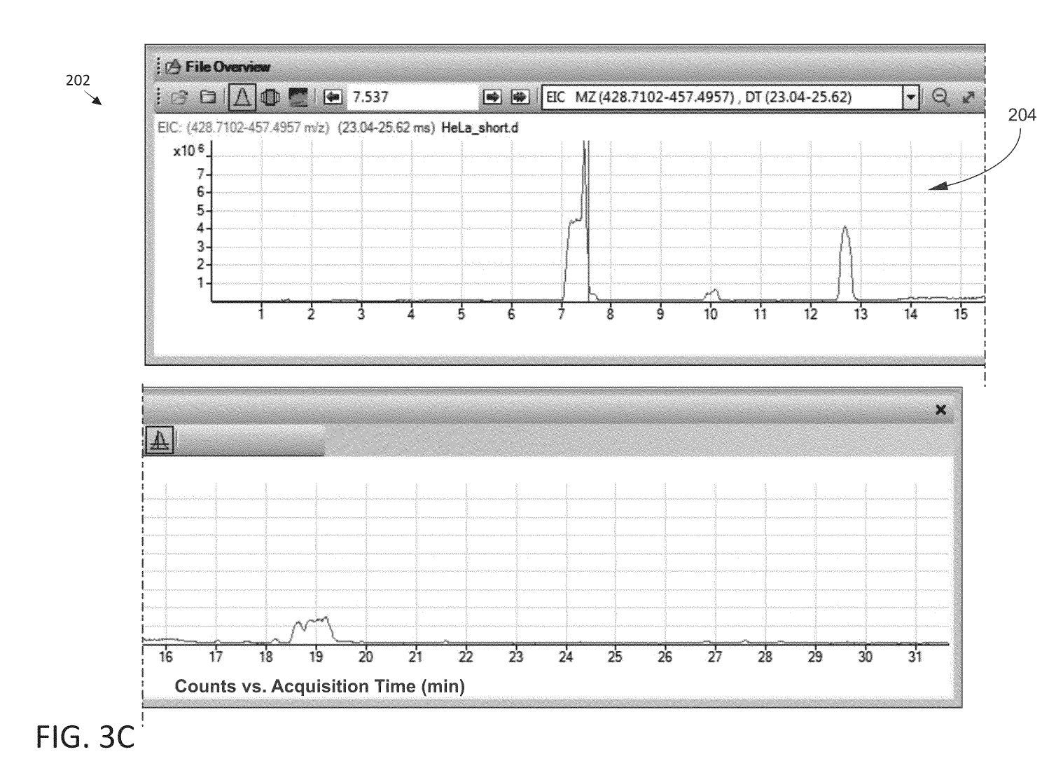

FIGS. 3A to 3C are examples of the first display area 202, each including a different example of the acquisition time region 204. In each example, the acquisition time region 204 includes an ion measurement graph plotting ion measurement data (e.g., ion signal intensity) as a function of acquisition time (or retention time). Acquisition time relates to the overall time duration of a sample analysis over which measurement data was acquired. Acquisition time is typically presented on the scale of minutes (min). Other dimensional units for the acquisition time scale may be selected, such as seconds (sec or s) or “frame number” units. As used herein, a “frame” is a set of mass spectra acquired at the same nominal acquisition time, with each mass spectrum corresponding to a different drift time. One frame is equivalent to one point in acquisition time (e.g., retention time along a chromatogram). The total ion signal intensity may be given in units such as counts (as detected by the ion detector).

In FIG. 3A, the ion measurement graph is an unfiltered total ion (current) chromatogram (TIC), in which the summed value of total ion signal (current) intensity (y-axis) is plotted as a function of the acquisition time (x-axis). In FIGS. 3B and 3C, the ion measurement graphs are each an extracted ion (current) chromatogram (EIC), in which the summed value of extracted ion signal (current) intensity (y-axis) is plotted as a function of the acquisition time (x-axis). The EIC in FIG. 3B is the result of filtering the chromatogram data based on a selected mass range. The EIC in FIG. 3C is the result of filtering the chromatogram data based on both a selected mass range and a selected drift range. An EIC may also be the result of filtering the chromatogram data based on a selected drift range only (not shown). The chromatogram displayed may also be a base peak chromatogram (BPC, not shown). The user may input commands to switch (toggle) the display in the first display area 202 among the different types of chromatograms. The user may also select the data range(s) (mass range, drift range, or both) by which to filter the data to display the desired type of EIC. Selection of desired data ranges for filtering may be done interactively via the plots of data displayed in the regions of the second display area 206 (FIG. 2), which are dynamically linked to the acquisition time region 204, as described below. For example, an EIC may be extracted by selecting a limited drift time range and/or m/z range from the map region 208 of the second display area 206, by selecting a limited drift time range from the drift spectrum region 210 of the second display area 206, or by selecting a limited m/z range from the mass spectrum region 212 of the second display area 206. Making the selection in the second display area 206 may be followed by invoking an “extract data” command, resulting in the newly generated EIC being displayed in the first display area 202.

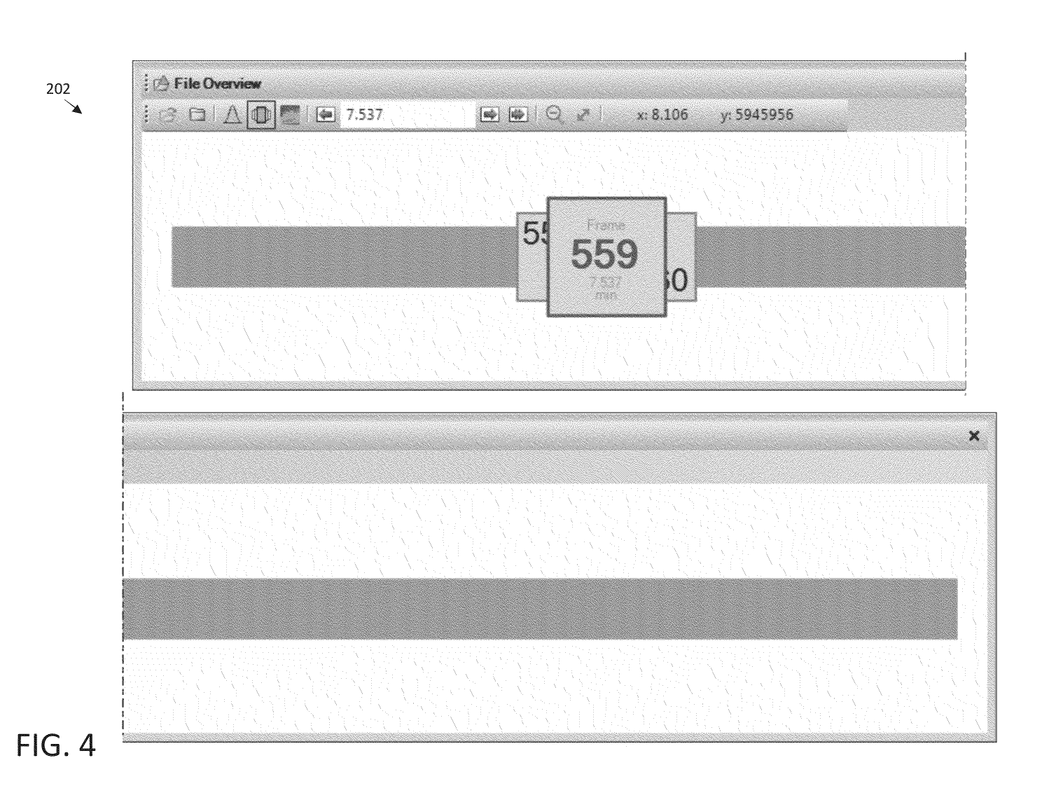

FIG. 4 is an example of the first display area 202 that includes a “frame selector” view. The user may toggle the display in the first display area 202 between the frame selector view and the ion measurement graphs (e.g., FIGS. 3A to 3C). The frame selector view includes a bar along which the cursor of a pointing device may be moved to highlight specific frames. A highlighted frame may be represented by a box on the bar, such as frame number 559 in the illustrated example. The pointing device may be utilized to select a specific frame or range of frames, for example by clicking on a box. Upon selection of a desired frame, the regions in the second display area 206 (i.e., those regions that are dynamically linked to the acquisition time region 204) may be dynamically changed or updated to display spectral data corresponding to the selected frame (i.e., selected point in acquisition time).

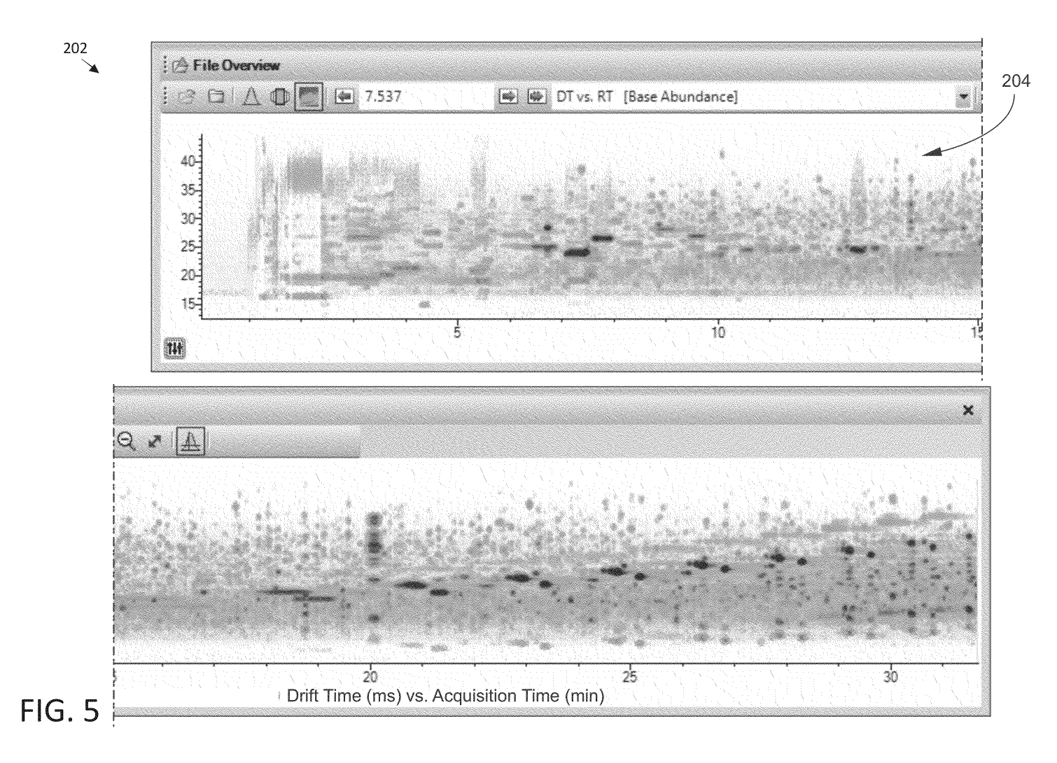

FIG. 5 is an example of the first display area 202 that includes an ion measurement graph that provides an overview of the overall sample analysis. This graph plots ion abundance versus drift time versus acquisition time (as illustrated), or ion abundance versus m/z ratio versus acquisition time (not shown). To visualize these three types of data simultaneously, the graph may be displayed as a 3D graph or a pseudo-3D graph (or “acquisition time map”). In the illustrated example, the graph is displayed as a heat map (or “abundance map”) in which acquisition time is plotted along one axis (e.g., the x-axis, or horizontal axis in the illustrated example), drift time (or m/z ratio) is plotted along an orthogonal axis (a drift time axis or m/z ratio axis, or y-axis, which is the vertical axis in the illustrated example), and ion abundance is shown as a color at any given x-y coordinate in the graph containing ion measurement data. Drift time is typically scaled in units of milliseconds (ms), although other units may be utilized such as drift bins. The color-coding of abundance values may be configured according to a variety of encoding schemes. Generally, different (varying) abundance values are displayed as different (varying) colors. As examples, color may vary from white to dark green to indicate lower to higher abundance, or from black to blue to green to yellow to red to indicate lower to higher abundance. In the present context, different or varying colors may refer to changes in a property (e.g., tint, tone, hue) of the same color; for example, lighter greens to darker greens may lower to higher abundance. A variety of color encoding schemes may be utilized such as, for example linear, logarithmic, square-root, etc. In some embodiments, the color encoding scheme may be configured by the user, and/or the user may toggle the display in the first display area 202 between different pre-existing color encoding schemes. The user may also toggle the display in the first display area 202 among the heat map, the other types of ion measurement graphs, and the frame selector view.

In some embodiments, the heat map displayed in the first display area 202 may be filtered on the basis of a selected data range (drift range or mass range). This filtering (i.e., selection of a data range) may be done interactively via the plots of data displayed in the regions of the second display area 206 (FIG. 2), which are dynamically linked to the acquisition time region 204, as described below. For example, a drift time versus retention time heat map filtered by a limited m/z range may be extracted by selecting the limited m/z range from the map region 208 (map) or the mass spectrum region 212 (side-plotted mass spectrum) displayed in the second display area 206 (described below). Similarly, an m/z ratio versus retention time heat map filtered by a limited drift time range may be extracted by selecting the limited drift time range from the map region 208 (map) or the drift spectrum region 210 (side-plotted drift spectrum) displayed in the second display area 206 (described below). In either case, making the selection in the second display area 206 may be followed by invoking an “extract data” command, resulting in the newly extracted (and filtered) heat map being displayed in the first display area 202.

In some embodiments, in a heat map plotting abundance versus drift time versus acquisition time such as shown in FIG. 5, the color-coded abundance may by default be based on the largest abundance seen at any m/z value in the spectrum at each (drift time, retention time) point. The user interface may allow the user to select (specify) an m/z range and extract a heat map in which the abundance is instead the largest abundance seen at any m/z value in the selected m/z range. The user may select a specific m/z range by interacting with a heat map displayed in the map region 208 (FIG. 2) of the second display area 206, or with a mass spectrum displayed in the mass spectrum region 212 of the second display area 206, as described further below. Likewise, in a heat map plotting abundance versus m/z ratio versus acquisition time, the color-coded abundance may by default be based on the largest abundance seen at any drift time value in the spectrum at each (m/z ratio, retention time) point. The user interface may allow the user to select (specify) a drift time range and extract a heat map in which the abundance is instead the largest abundance seen at any drift time value in the selected drift time range. In either case, the extracted heat map may then be displayed in the first display area 202, and provides yet another “slice” of data helpful for understanding the data acquired from the sample analysis.

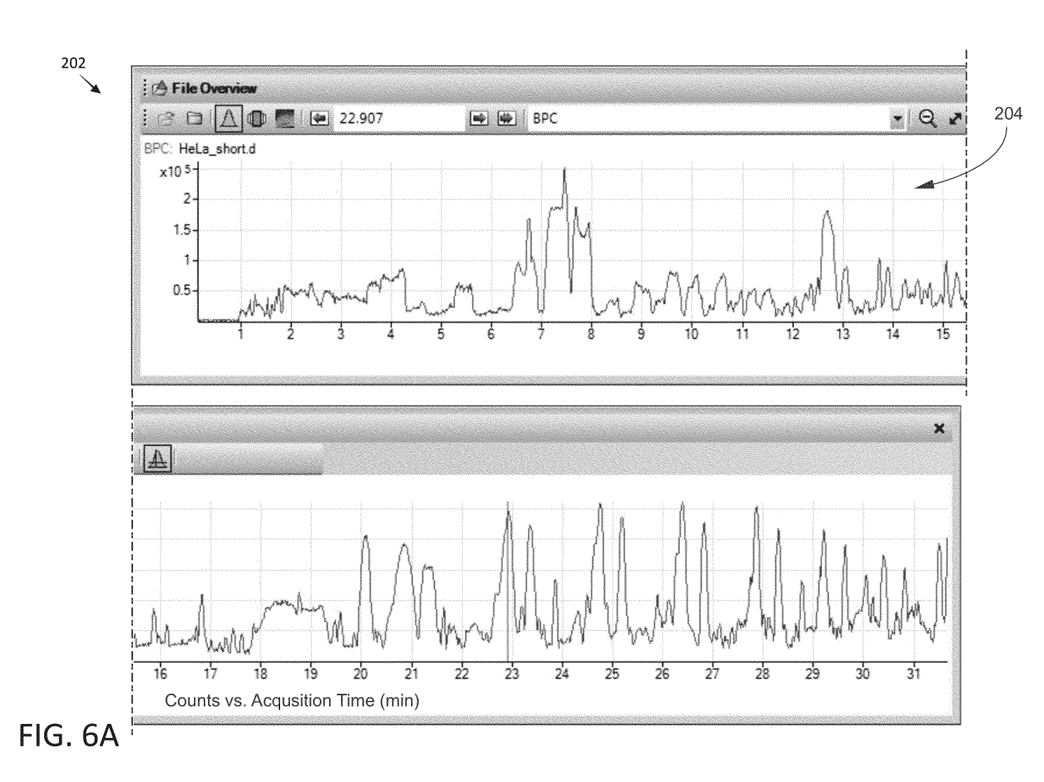

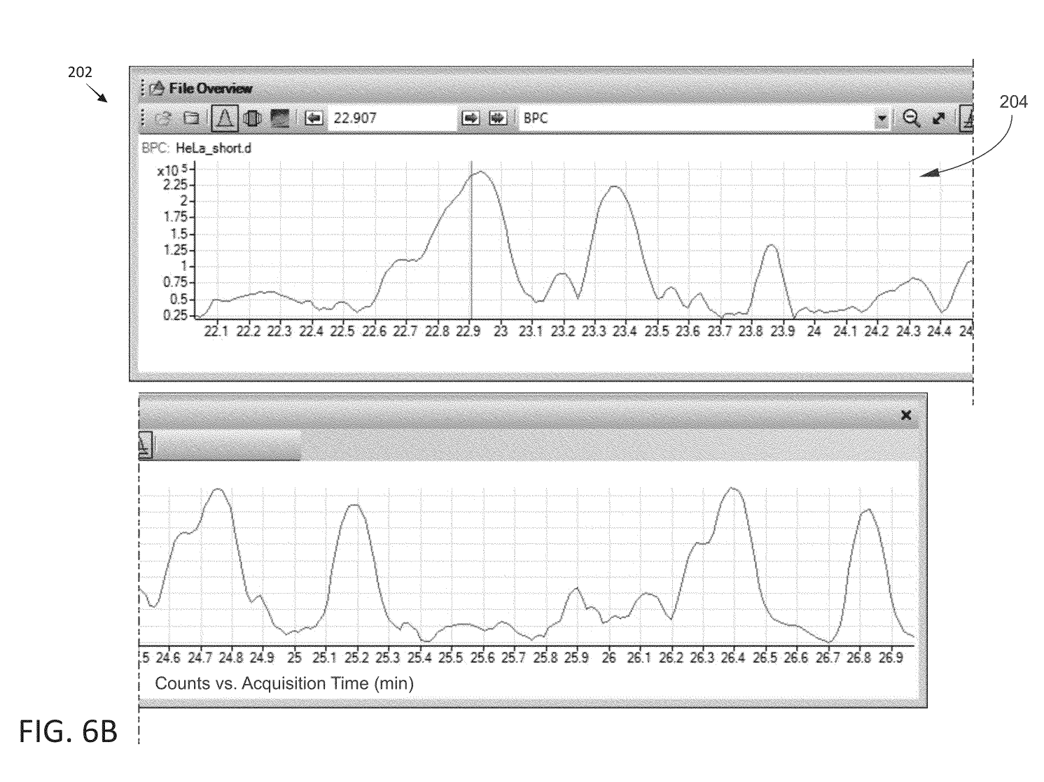

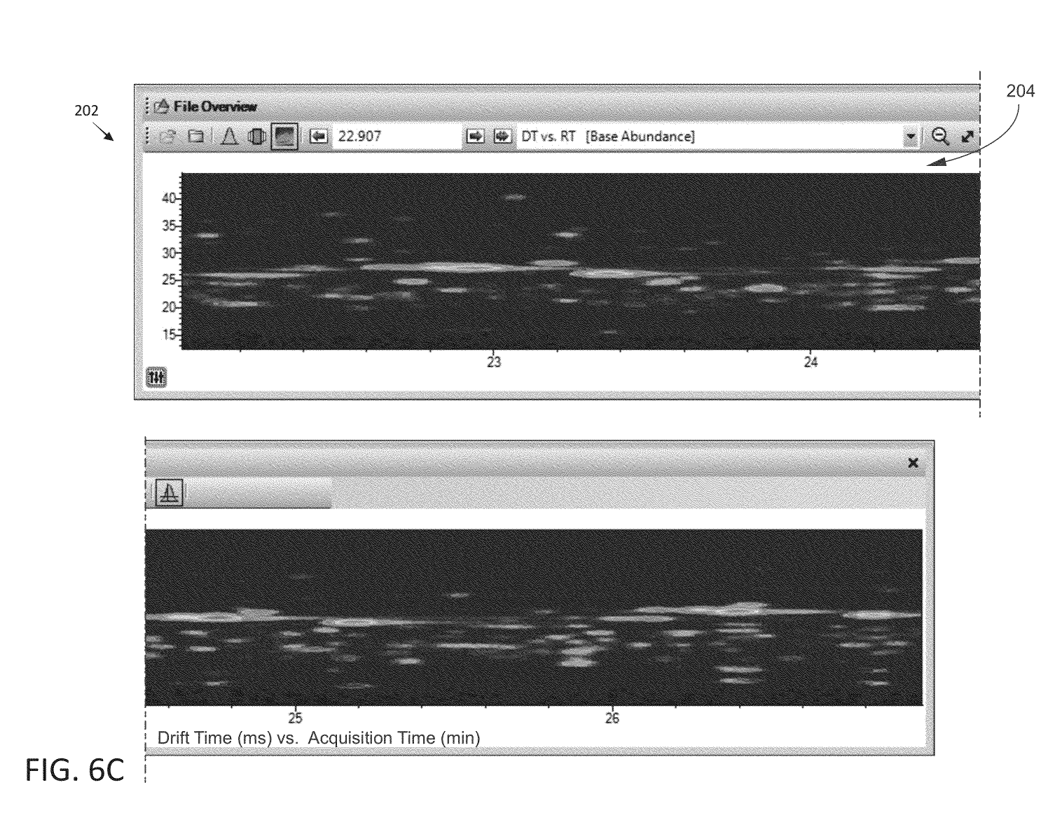

The various ion measurement graphs (e.g., chromatograms and maps) displayable in the first display area 202 may be dynamically linked to each other, such that changing (e.g., narrowing, broadening, shifting) the range over which selected data is displayed in one graph causes the range over which corresponding data is displayed in another graph to change as well. For example, respective data ranges in different ion measurement graphs may be linked. This is illustrated in FIGS. 6A to 6C. FIG. 6A is an example of the first display area 202 that includes an overall chromatogram spanning the full duration of a sample analysis (in the illustrated example, about 32 minutes). The user may wish to focus attention on a certain period of time transpiring within the overall duration of the analysis, which may be done by selecting a specific range of time to be displayed. Generally, the range selection may be done by any suitable means of user input such as, for example, keystrokes to enter endpoints of the selected range, clicking or dragging a pointing device to define the endpoints of the selected range, etc. Range selection may entail zooming in or out of the currently displayed graph, shifting the time values currently displayed forward (upward) or backward (downward), etc. FIG. 6B is an example of the first display area 202 that includes a chromatogram that results after selecting the acquisition time range of 22 to 27 minutes originally part of the full duration (0 to 32 minutes) displayed in FIG. 6A. In addition, after selecting a new data range such as the acquisition time range, the ion measurement graph currently displayed may be switched to another type of ion measurement graph, which may display its data according to the newly selected data range. As one example, the chromatogram shown in FIG. 6B may be switched to a heap map view, as shown in FIG. 6C. Thus, FIG. 6C is an example of the first display area 202 that includes a heat map plotting ion abundance versus drift time versus acquisition time, where the acquisition time visible is limited to the range of 22 to 27 minutes previously selected and displayed in the chromatogram of FIG. 6B.

Generally, in some embodiments, utilizing a pointing device to right-click in any display area may bring up a context menu of actions that are currently able to be done in that display area, and/or one or more actions made currently available as a result of a previous “selection” made in that display area. Such actions may include an action that extracts additional data based on a selection previously made. From any 2D plot, the newly extracted data may be summed across whatever the x-axis dimension is in the current plot. For example, an extraction from a chromatogram may be summed across an acquisition time range selected by the user.

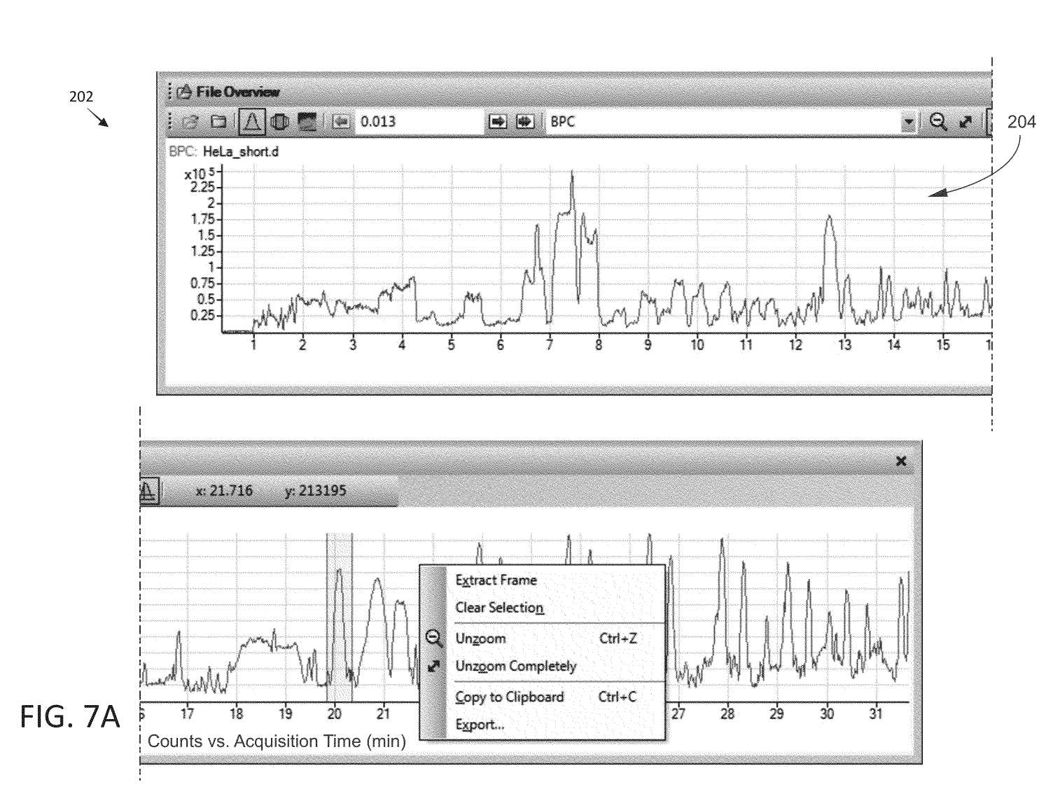

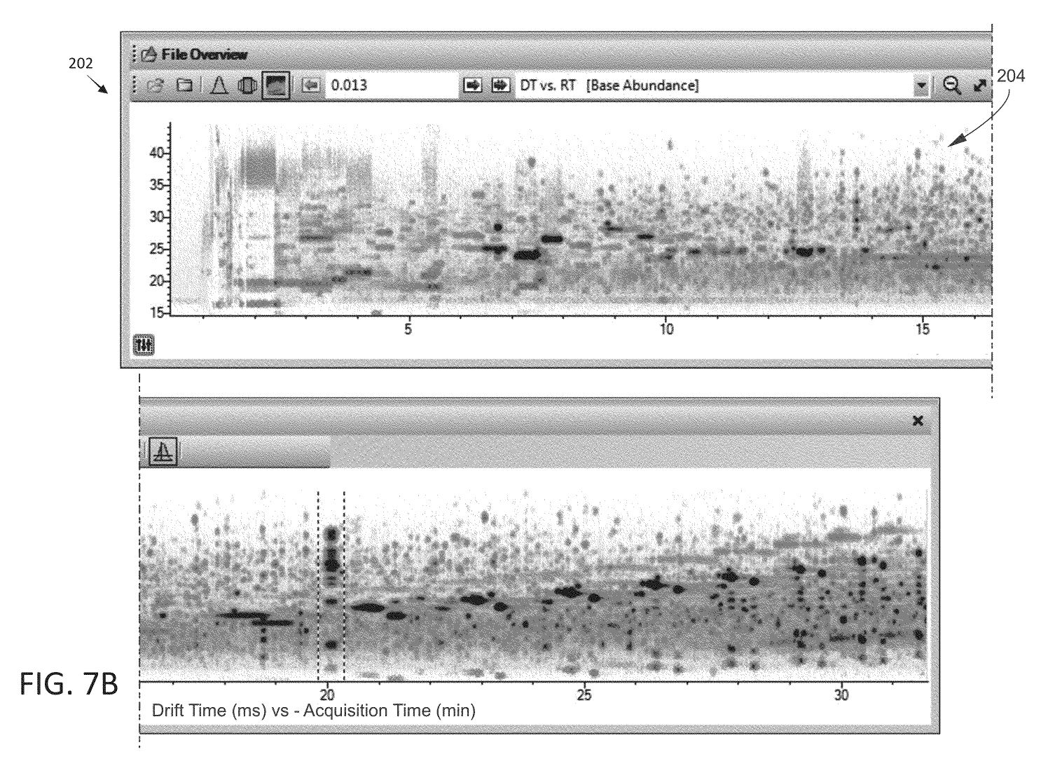

FIGS. 7A and 7B illustrate an example of how a data range selection may be made in a 2D plot according to some embodiments. FIG. 7A is an example of the first display area 202 that includes a chromatogram, in which an acquisition time range has been selected and a context menu has been invoked. In this example, a pointing device has been utilized to perform a left click-drag operation to select the acquisition time range. As a result, two parallel, vertical lines defining values in (typically the end points of) the selected range are displayed. Also, the area between the two vertical lines may be shaded, colored, or otherwise highlighted as illustrated. Alternatively, the selected range may be a zero-width range, i.e., a single data value. A zero-width range may be selected just by left-clicking, and may be represented by just a single vertical line in the display area. Once the data range has been selected, right-clicking with the pointing device may bring up a context menu such as shown in FIG. 7A, which includes an Extract Frame command. Clicking on the Extract Frame command will extract frame data that is summed over the current selection's range. In some embodiments, after selecting the data range, using the pointing device to double-click in the selected area displayed may initiate the extraction operation as a default action, without needing to then also select the Extract Frame command from the context menu. The extracted frame data may then be displayed in one or more other regions of the screen display 200 outside of the first display area 202 that contain corresponding data, such as one or more regions of the second display area 206 (assuming those other regions are dynamically linked to the acquisition time region 204 of the first display area 202). That is, the display of data in the other region(s) may be updated to display data according to the data range selected in the first display area 202. This is described in more detail below.

Range selections may also be dynamically linked between different types of ion measurement graphs displayable in the first display area 202, such that a range selection made in one ion measurement graph is also displayed in another ion measurement graph when switching between the two graphs. FIG. 7B is an example of the first display area 202 that includes an overall heat map corresponding to the chromatogram illustrated in FIG. 7A. In FIG. 7B, a graphical representation of the acquisition time range selected in the chromatogram of FIG. 7A is also displayed in the heat map. In the illustrated example, this graphical representation is in the form of two parallel, vertical dotted lines demarcating the same selected range displayed in the chromatogram of FIG. 7A. Thus, FIG. 7A displays a representation of the data range selected by the user, and FIG. 7B displays a corresponding representation of the selected data range.

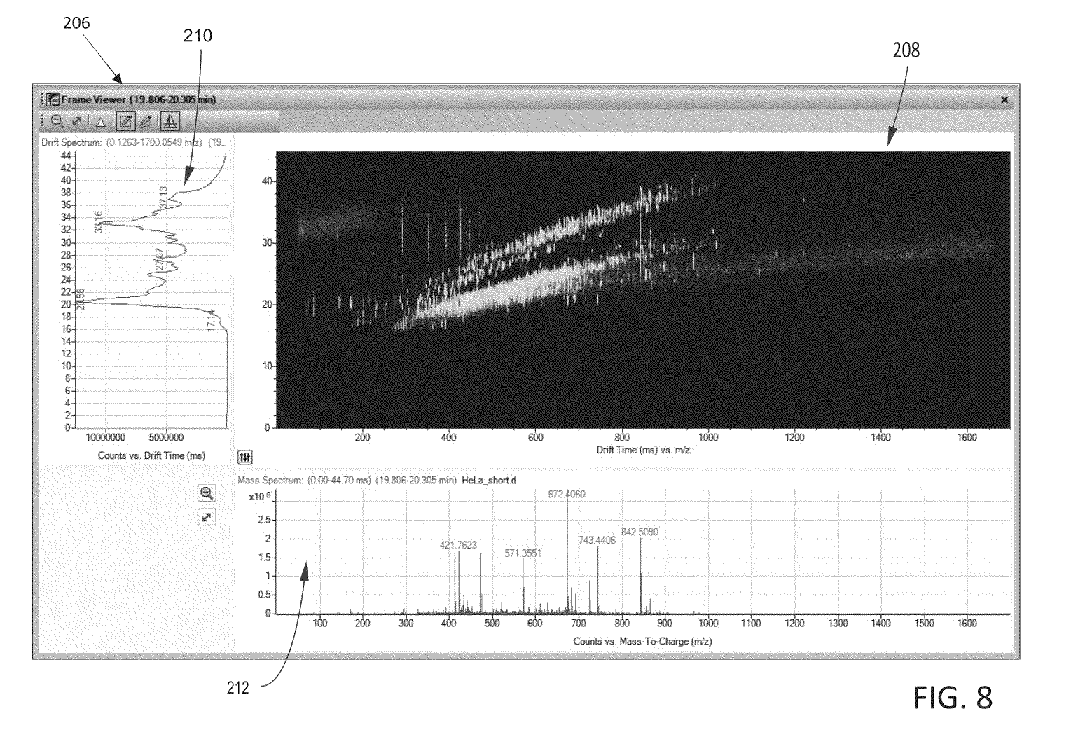

FIG. 8 is an example of the second display area 206 that includes multiple display regions, specifically the map region 208, the drift spectrum region 210, and the mass spectrum region 212. In some embodiments, the second display area 206 is dynamically linked to the first display area 202 such that any acquisition time “slice” of data extracted via a range selection made in the first display area 202 (as described above) is displayed in the second display area 206. In a specific embodiment, the map region 208, drift spectrum region 210, and mass spectrum region 212 are each dynamically linked to the acquisition time region 204 of the first display area 202, and thus provide three alternative views of the same extracted data slice. Additionally, in some embodiments the map region 208, drift spectrum region 210, and mass spectrum region 212 are dynamically linked to each other, such that after changing a data range in one region, the other regions consistently show the same portion of the data (i.e., reflecting the change made to the range), as described further below.

The map region 208 includes a graph plotting ion abundance versus drift time versus m/z ratio. To visualize these three types of data simultaneously, the graph may be displayed as a 3D graph or a pseudo-3D graph (or map). In the illustrated example, the graph is displayed as a heat map in which m/z ratio is plotted along one axis (an m/z ratio axis, which is the x-axis, or horizontal axis, in the illustrated example), drift time is plotted along an orthogonal axis (a drift time axis, which is the y-axis, or vertical axis, in the illustrated example), and ion abundance is shown as a color at any given x-y coordinate in the graph containing ion measurement data. Drift time is typically scaled in units of milliseconds (ms), although other units may be utilized such as drift bins. The values of m/z ratio may be given in m/z (Thompsons or Daltons) or, if the mass analyzer is a TOF analyzer, in flight time (e.g., nanoseconds). The color-coding of abundance values may be configured as described above.

The drift spectrum region 210 is a dynamic drift spectrum plotting ion signal intensity as a function of drift time. The signal intensity may be given in units such as counts (as detected by the ion detector). The drift spectrum may be displayed as a 2D projection (or “side plot”) from the drift time axis of the map. As such, the drift time axis of the drift spectrum is displayed in parallel with the drift time axis of the map. The drift spectrum is “dynamic” in that it is dynamically linked to the map whereby the range of drift times displayed in the drift spectrum matches the range of drift times displayed in the map. Hence, the drift time axis of the drift spectrum is scaled in the same units, and spans the same range of drift time (0 to 43 ms in the illustrated example), as the drift time axis of the map. The ion abundance (signal intensity) shown in the drift spectrum at any given drift time point is summed over the m/z range currently visible in the map.

The mass spectrum region 212 is a dynamic mass spectrum plotting ion signal intensity (vertical axis, in the illustrated example) as a function of m/z ratio (horizontal axis, in the illustrated example). The signal intensity may be given in units such as counts (as detected by the ion detector). The mass spectrum may be displayed as a 2D projection (or “side plot”) from the m/z ratio axis of the map. As such, the m/z ratio axis of the mass spectrum is displayed in parallel with the m/z ratio axis of the map. The mass spectrum is “dynamic” in that it is dynamically linked to the map whereby the range of m/z ratios displayed in the mass spectrum matches the range of m/z ratios displayed in the map. Hence, the m/z ratio axis of the mass spectrum is scaled in the same units, and spans the same range of m/z ratio (50 to 1650 m/z in the illustrated example), as the m/z ratio axis of the map. The ion abundance (signal intensity) shown in the mass spectrum at any given m/z ratio value is summed over the drift range currently visible in the map.

The graphs displayed in the map region 208, drift spectrum region 210, and mass spectrum region 212 may be resized relative to each other by using a pointing or other type of user input. Also, the axes along which drift time and m/z ratio are plotted may be switched. Hence, in comparison to FIG. 8, the drift time axis of the map may be switched from the vertical axis to the horizontal axis, and the m/z ratio axis of the map may be switched from the horizontal axis to the vertical axis. This swapping of data axes would result in the positions of the drift spectrum and mass spectrum being swapped as well. That is, the drift spectrum would then be displayed in the mass spectrum region 212 (below the map) and the mass spectrum would be displayed in the drift spectrum region 210 (left of the map).

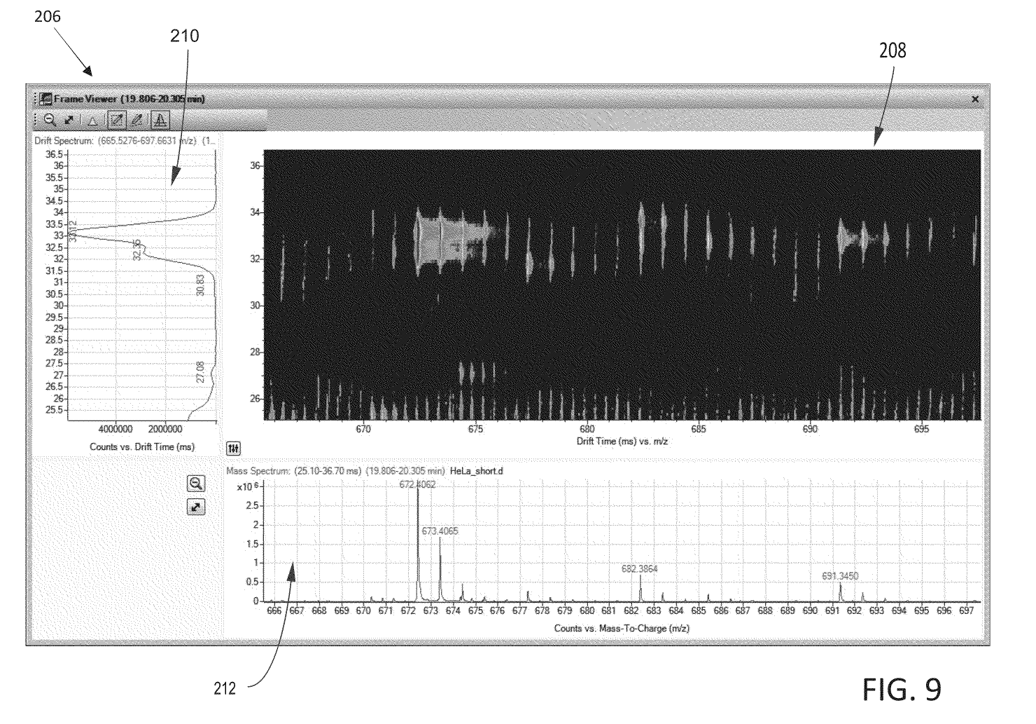

FIG. 8 is a fully zoomed out view of the full slice of data extracted from the overall chromatogram displayed in the first display area 202 (see, e.g., FIGS. 7A and 7B). In any region of the second display area 206, additional changes in data ranges (e.g., drift time range and/or m/z range) displayed may be made to further focus on portions of data (e.g., peaks) of interest to the user. Range selections may be effected by the same types of user inputs described above in relation to the first display area 202 (e.g., keyboard strokes, pointing device manipulations, etc.). For example, range selections may be made in the map, the drift spectrum, or the mass spectrum via a right click-drag, or in the drift spectrum or the mass spectrum via left or right click-drag operations on the axis labels of either the x- or y-axes. Because the graphs are dynamically linked to each other, changing a range of data displayed in one graph will cause the same change to corresponding data displayed in any of the other graphs that include corresponding data (e.g., the same type of data). As examples, changing the drift time range (drift range) in the drift spectrum will cause the same change to the drift time range in the map, and changing the m/z range (mass range) in the mass spectrum will cause the same change to the m/z range in the map. Moreover, data ranges may be changed from the map with a symmetrical effect on the drift spectrum and/or mass spectrum. As examples, changing the drift time range in the map will cause the same change to the drift time range in the drift spectrum, and changing the m/z range in the map will cause the same change to the m/z range in the mass spectrum. Moreover, both the drift time range and the m/z range may be changed from the map, resulting in the same change to the drift time range in the drift spectrum and the same change to the m/z range in the mass spectrum. The result of this latter, two-dimensional change to displayed data ranges is illustrated in FIG. 9, which is an example of the second display area 206 displaying the same frame of data as that illustrated in FIG. 8, but zoomed in to a narrower drift time range (25 to 36.5 ms) and m/z range (665.5 to 697.5).

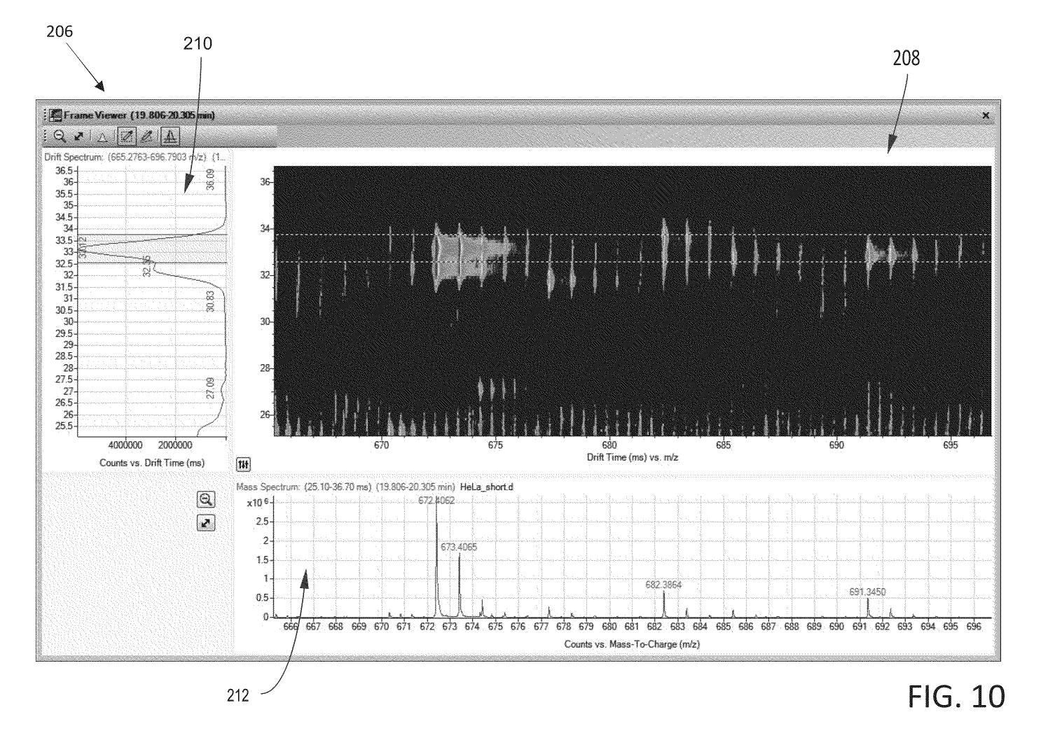

FIG. 10 is an example of the second display area 206 displaying the same graphs as that illustrated in FIG. 9, illustrating an example of selecting a range of data. Making selections in the second display area 206 may be similar to making selections in the first display area 202. However, a selection made in one graph may also be projected onto any of the other graphs containing corresponding data. In the example illustrated in FIG. 10 a drift time range has been selected in the drift spectrum, as represented by two parallel, horizontal lines corresponding to the end points of the selected range and with the area bounded by the two parallel lines highlighted. This range selection is also projected from the drift time axis of the map, which in this example is represented by two parallel, horizontal dotted lines extending across the m/z range visible in the map. Analogously, an m/z range may be selected (not shown) in the mass spectrum and the representation of this range selection may be projected in the map across the drift time range visible in the map. Moreover, a drift time range and/or m/z range may be selected in the map with a symmetrical effect, i.e., the range selection(s) being projected onto the drift spectrum and/or mass spectrum.

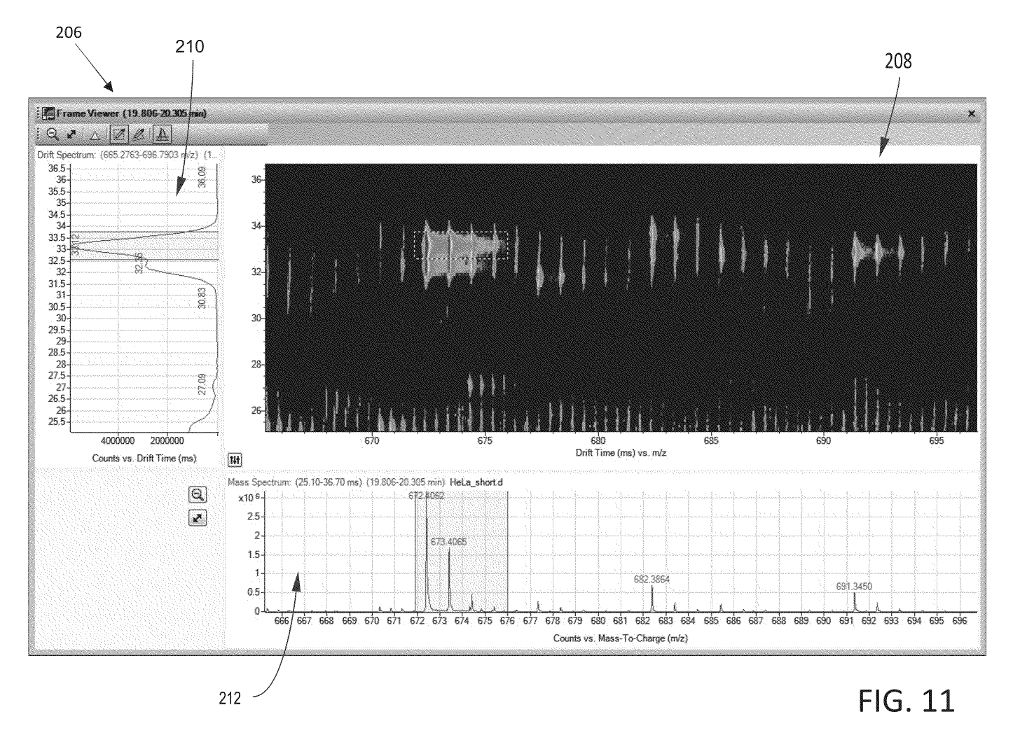

FIG. 11 is an example of the second display area 206 displaying the same graphs as that illustrated in FIGS. 9 and 10, illustrating an example of selecting ranges of two types of data. As an example, a pointing device may be utilized to draw a polygon (or selection region) such as a rectangular box on the map. The box is bounded by a first pair of parallel lines demarcating the selected drift time range and a second pair of parallel lines demarcating the selected m/z range. The first pair of parallel lines are then projected onto the drift spectrum and the second pair of parallel lines are projected onto the mass spectrum. Again, the selection process is symmetrical; range selections may first be made in the drift spectrum and the mass spectrum, resulting in pairs of parallel lines being projected onto the map (at least those portions of the projected lines defining a closed polygon in the map).

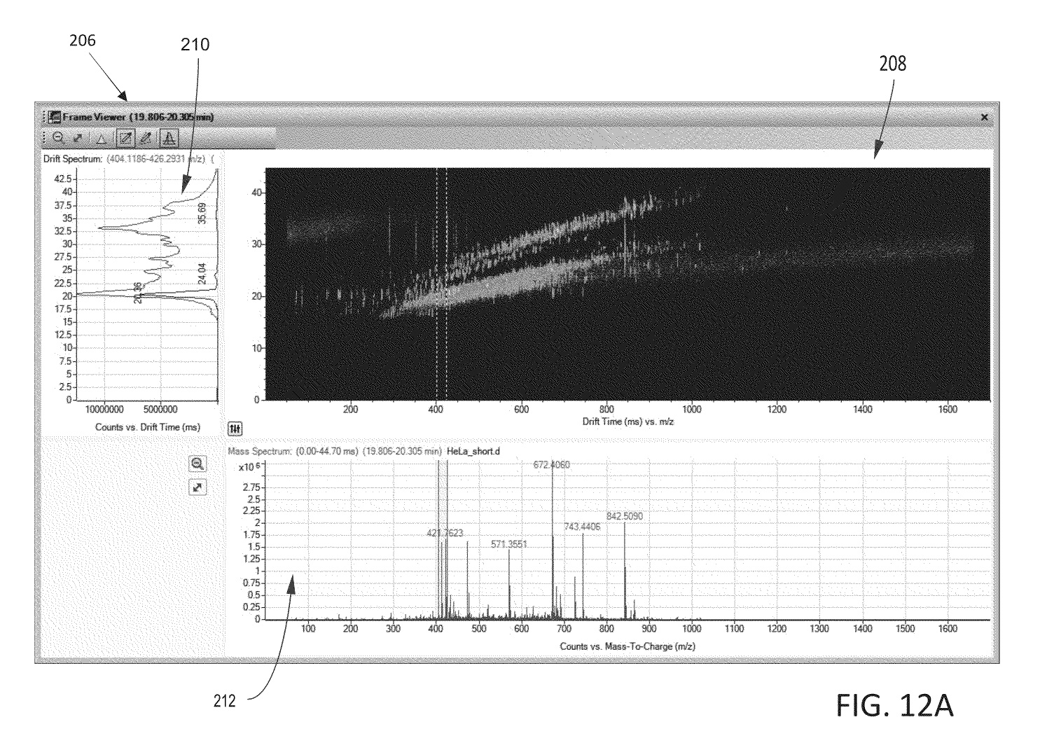

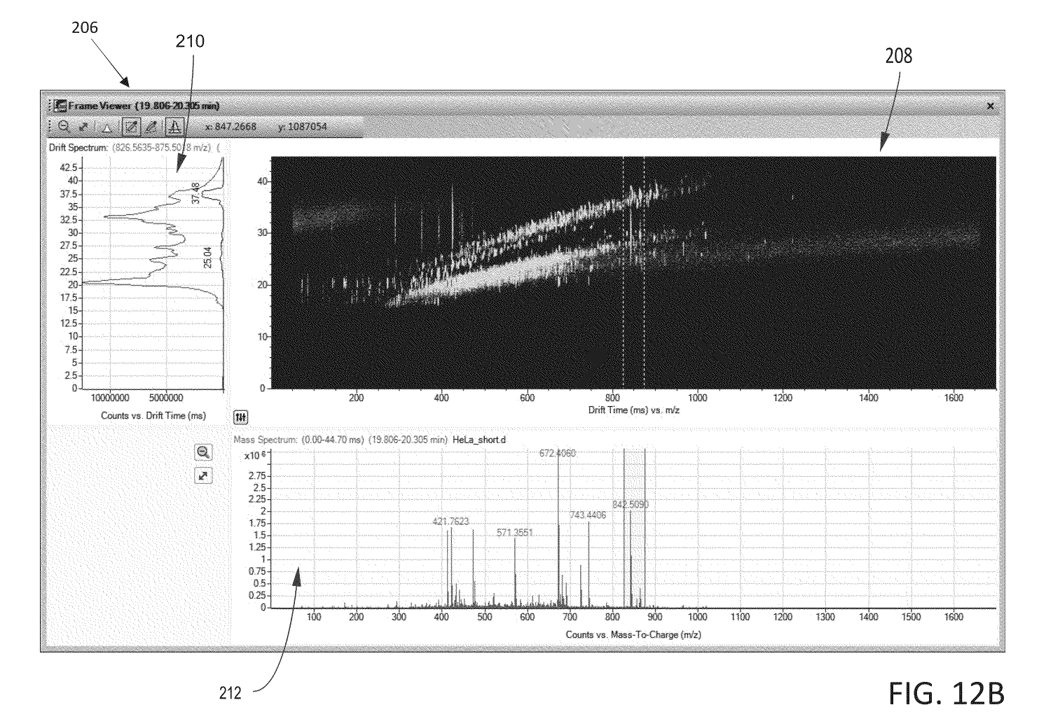

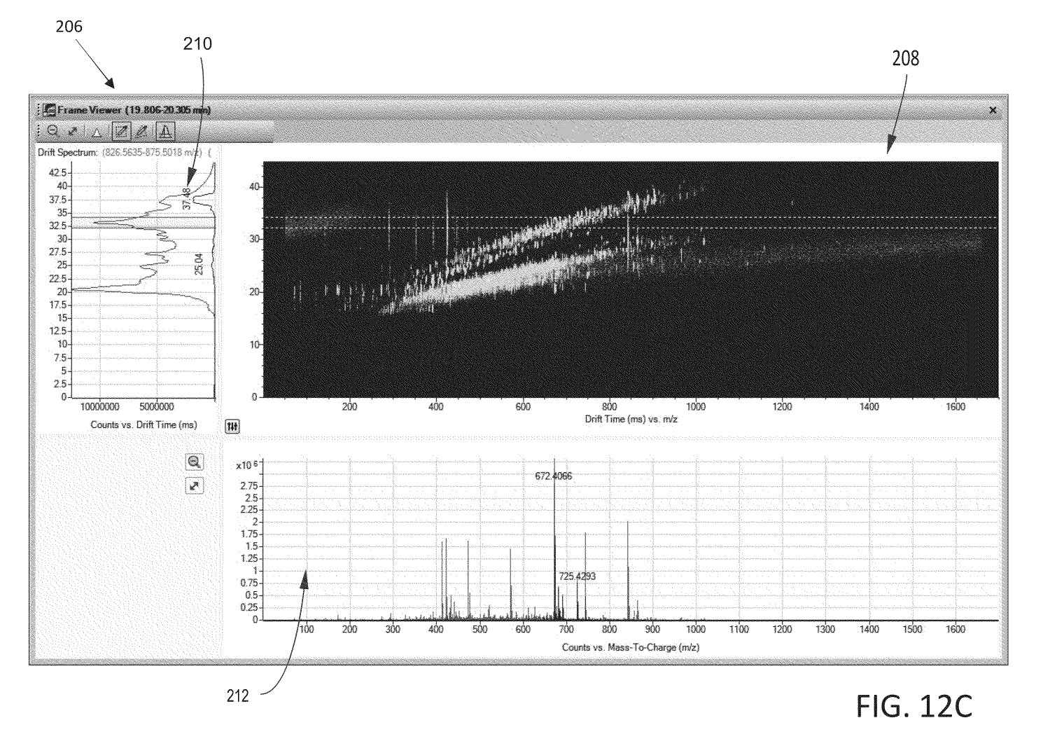

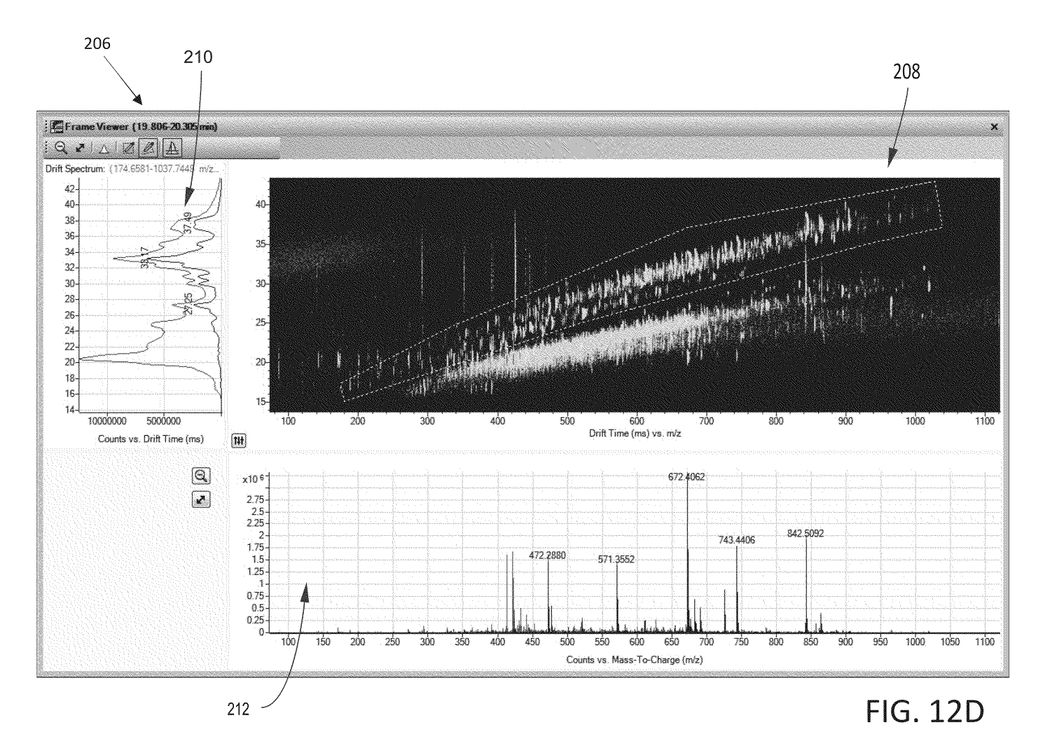

A range selection made in the second display area 206 may also be utilized to extract (generate) a new spectrum based on the data range selected, which may be referred to herein as a custom spectrum (e.g., custom drift spectrum or custom mass spectrum). A custom spectrum may be saved to memory and/or displayed in the third display area 214 labeled User Drift Spectra (or User Mass Spectra) shown in FIG. 2. FIG. 12A is an example of the second display area 206 in which a custom drift spectrum has been generated based an m/z range selected in the dynamic mass spectrum. In this example, the custom drift spectrum is displayed as an overlay on the pre-existing dynamic drift spectrum. The custom drift spectrum may be distinguished from the dynamic drift spectrum by any graphical means, such as by a different color, a different type of line (e.g., dotted or dashed versus solid, different line widths, etc.), different shapes of data points (e.g., circles, diamonds, squares, triangles, etc.), etc. User selections may be made as to whether both the custom drift spectrum and the dynamic drift spectrum are visible, or whether just the newly generated custom drift spectrum is visible (e.g., whether the newly created custom drift spectrum replaces the dynamic drift spectrum, or replaces a previously generated custom drift spectrum if applicable). A custom spectrum (e.g., custom drift spectrum) always shows the abundance summed over the data range (e.g., m/z range) utilized to generate the custom spectrum, no matter what the current visible range of the map may be (and regardless of whether the data range of the custom spectrum is even visible in the map). In this respect, a custom spectrum is different than a dynamic spectrum in that the abundance plotted in the dynamic spectrum typically always shows the abundance summed over the data range currently visible in the map. It will be noted that dynamic spectra may also be copied to the user spectra of the third display area 214.

FIG. 12B is an example of the second display area 206 in which a custom drift spectrum has been generated based on selection of a different m/z range as compared to FIG. 12A. Optionally (as illustrated in FIG. 12B), the custom drift spectrum may be overlaid on the dynamic drift spectrum as in the case of FIG. 12A. In one example, a first custom drift spectrum may be generated (e.g., as shown in FIG. 12A), and subsequently a second custom drift spectrum may be generated based on a different m/z range (e.g., as shown in FIG. 12B). In this case, the second custom drift spectrum may replace the previously generated first custom drift spectrum as the overlay on the dynamic drift spectrum. However, whenever any custom spectrum is generated, that custom spectrum may be moved to, copied to, or otherwise displayed in the third display area 214, as noted above. This may be done before generating another custom spectrum that is based on a different range of data. The third display area 214 may be configured to hold any number of different custom spectra generated in the manner described above. Thus, a plurality of custom spectra may be generated and arranged together in one place on the screen display 200, an example of which is described further below.

FIG. 12C is an example of the second display area 206 in which a custom mass spectrum has been generated based on a drift time range selected in the dynamic drift spectrum. Analogous to the display of custom drift spectra described above, the custom mass spectrum is displayed as an overlay on the pre-existing dynamic mass spectrum. For example, the peaks m/z=672 and 725 are part of the custom mass spectrum (displayed, for example, in black), while peaks in the range of 400 to 600 m/z and 800 to 900 m/z are part of the dynamic spectrum (displayed, for example, in blue, or a lighter shade than black in the black and white representation of FIG. 12C) but not part of the custom mass spectrum.

FIG. 12D is an example of the second display area 206, illustrating an example of selecting ranges of two types of data to generate corresponding custom spectra. In this example, range selections are made by drawing an irregular polygonal selection region on the map. Alternatively, the selection region drawn may be rounded or curved (e.g., circular, elliptical, etc.) This two-dimensional range selection results in the generation of a custom drift spectrum and a custom mass spectrum, which in the illustrated example are overlaid on the dynamic drift spectrum and dynamic mass spectrum, respectively.

More generally, in any of the embodiments disclosed herein involving range selections, a range selection may entail selecting more than one range of the same dimension (e.g., two ranges of drift time) displayed in a given data plot. The desired result (filtering, zooming, extracting spectra, etc.) will then be based on the multiple ranges selected. For example, the user may define two or more one-dimensional selection regions (e.g., pairs of parallel lines) or two-dimensional selection regions (e.g., closed polygons or curved shapes) in a given data plot. Two or more regions or ranges so selected may be overlapping or non-overlapping with each other.

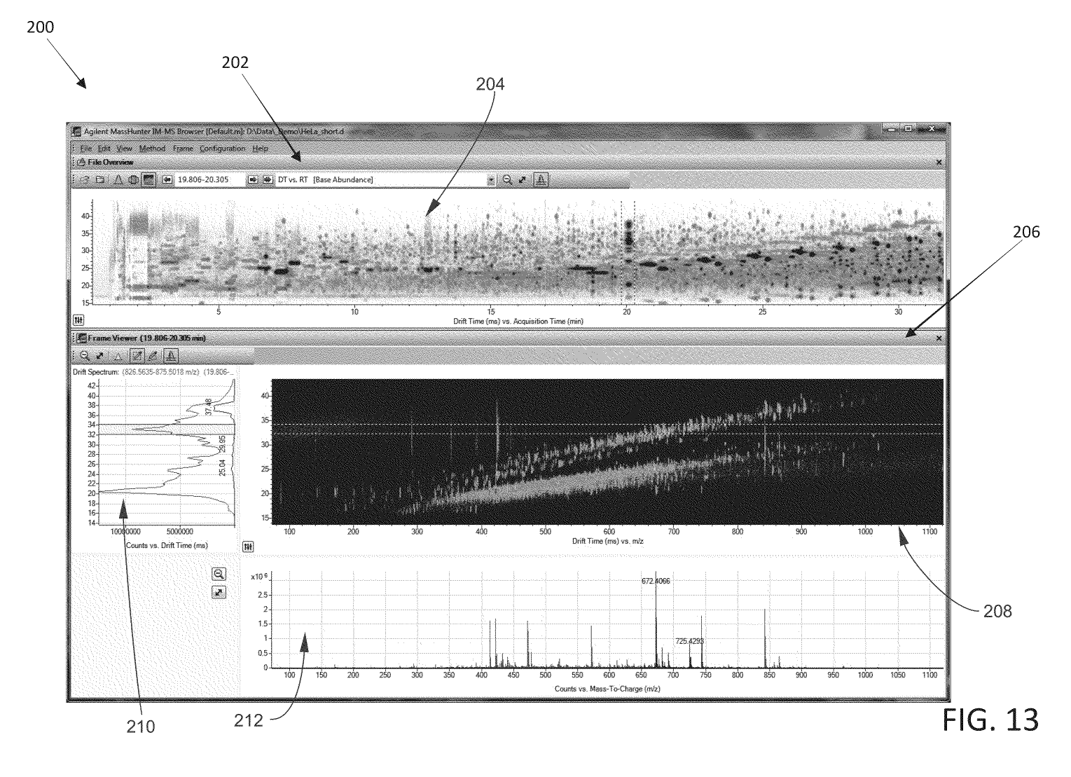

FIG. 13 is an example of the screen display 200, illustrating an example of the first display area 202 and the second display area 206. In the illustrated example, the acquisition time region 204 of the first display displays a heat map (abundance versus drift time versus acquisition time) representing an overview of the entire acquisition time range of a data file (e.g., the entire duration of a sample analysis performed by an IMS-MS system). Two parallel lines displayed in the map in the first display area 202 represent a selected range of acquisition time, or frame, extracted (or “sliced”) out from the overall acquisition time. The data displayed in the map region 208, drift spectrum region 210, and mass spectrum region 212 of the second display area 206 are based on the frame selected in the acquisition time region 204. The map region 208 displays a heat map plotting abundance versus drift time versus m/z ratio. The drift spectrum region 210 presents an alternative representation of the frame data as a dynamic drift spectrum. The mass spectrum region 212 presents another alternative representation of the frame data as a dynamic mass spectrum. Also, the drift spectrum region 210 includes a custom drift spectrum overlaid on the dynamic drift spectrum, and the mass spectrum region 212 includes a custom mass spectrum overlaid on the dynamic mass spectrum. Thus, it is evident that the screen display 200 and associated user interface offers the ability to easily see and navigate among multiple, linked views of the same data, with each graphical view emphasizing a different dimension or dimensions. Thus, the screen display 200 may provide a powerful aid to visualizing and manually interrogating the content of complex data files.

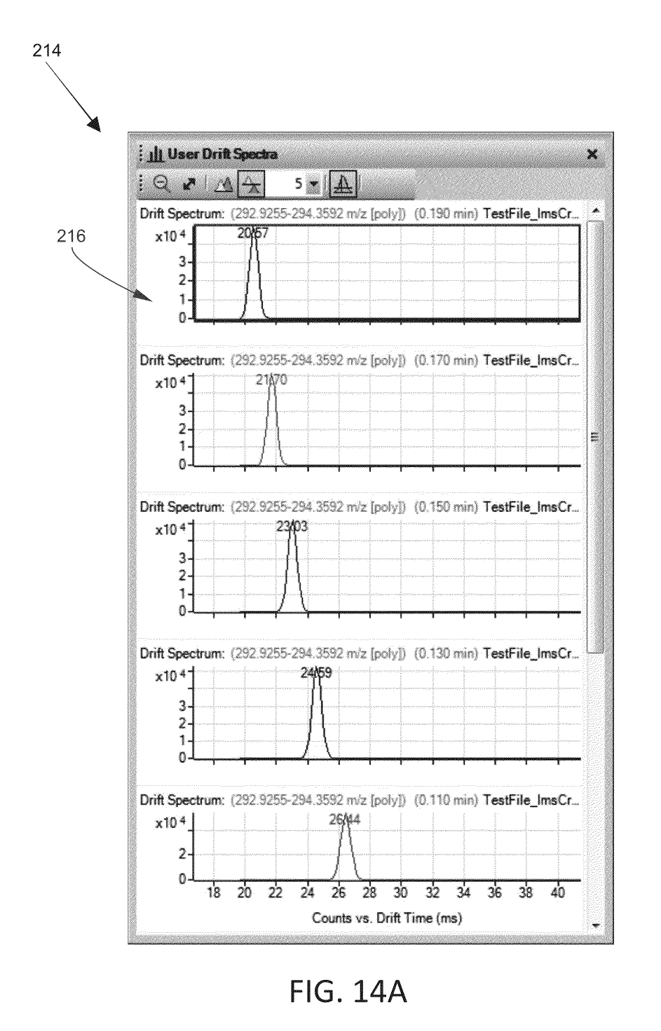

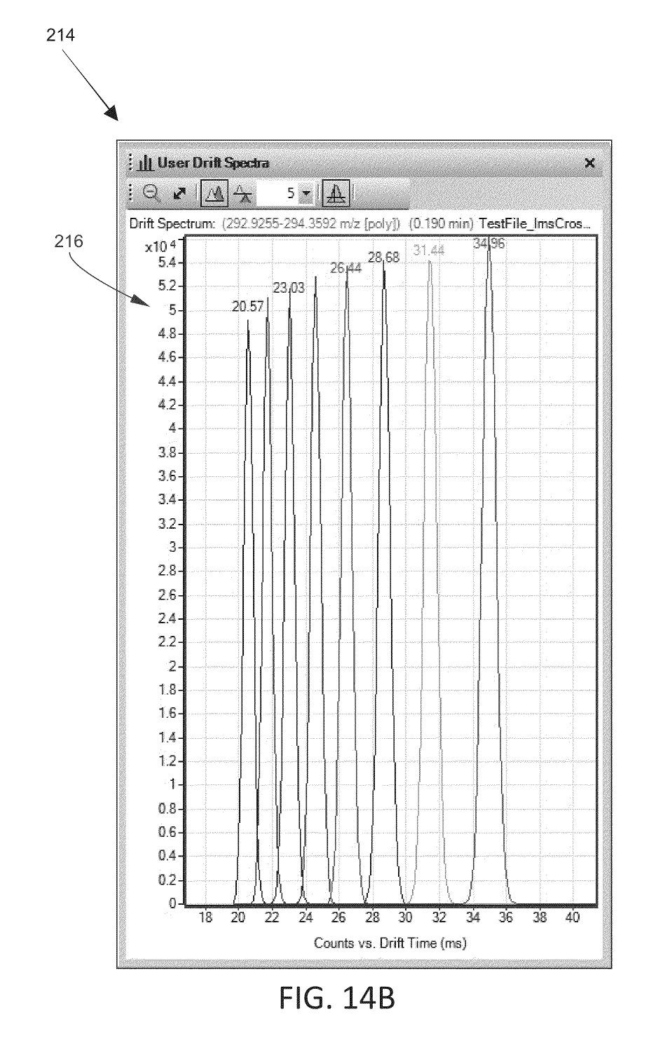

FIG. 14A is an example of the third display area 214 that includes a custom spectra region 216. The custom spectra region 216 may display one or more custom drift spectra (as illustrated) or custom mass spectra depending on user selection. The user may switch between displaying custom drift spectra and custom mass spectra, such as by selecting between a User Drift Spectra tab and a User Mass Spectra tab as illustrated in FIG. 2. As described above, whenever any custom spectrum is generated, that custom spectrum may be added to the custom spectra region 216 of the third display area 214, which may hold and display a plurality of custom spectra so generated. Stated in another way, each custom spectrum generated (or any number of selected custom spectra generated) may be added to the third display area 214 as a “bookmark” and held there for future reference. The custom spectra may be arranged in a variety of different modes selectable by the user for viewing in the third display area 214. For example, FIG. 14A illustrates a “list mode” in which each custom spectrum is displayed separately from the other custom spectra and includes its own respective drift time axis and a signal intensity axis. As another example, FIG. 14B is an example of the third display area 214 that includes a custom spectra region 216 displaying custom spectra in a different arrangement as compared to FIG. 14A. Specifically, FIG. 14B illustrates an “overlay mode” in which all of the custom spectra are plotted with reference to a single drift time axis and a single signal intensity axis and are overlaid on top of each other. As another example, multiple custom spectra may be stacked on top of each other in the third display area 214 but offset from each other to facilitate selection of an individual custom spectrum (not shown). Further alternative display modes may be made available, as appreciated by persons skilled in the art. The order in which the custom spectra are displayed in the custom spectra region 216 may be reordered as desired by the user.

In some embodiments, the user interface provides a “Go to bookmark” command made available to the user by any input means such as a context menu, etc., after selecting a specific custom spectrum (such as by clicking on it) currently displayed in the third display area 214. Execution of the “Go to bookmark” command returns the second display area 206 to the source data of the currently selected custom spectrum, whereby the graphs in the second display area 206 are displayed according to the data ranges of the selected custom spectrum. For example, after selecting an individual custom drift spectrum currently displayed in the third display area 214 and invoking the “Go to bookmark” command, the selected custom drift spectrum may be shown in the drift spectrum region 210 of the second display area 206 (and optionally overlaying a dynamic drift spectrum), and the m/z range utilized to extract the custom drift spectrum may be graphically indicated (e.g., by parallel lines, shaded area, etc., as described above) in the map (map region 208) and dynamic mass spectrum (mass spectrum region 212) of the second display area 206.

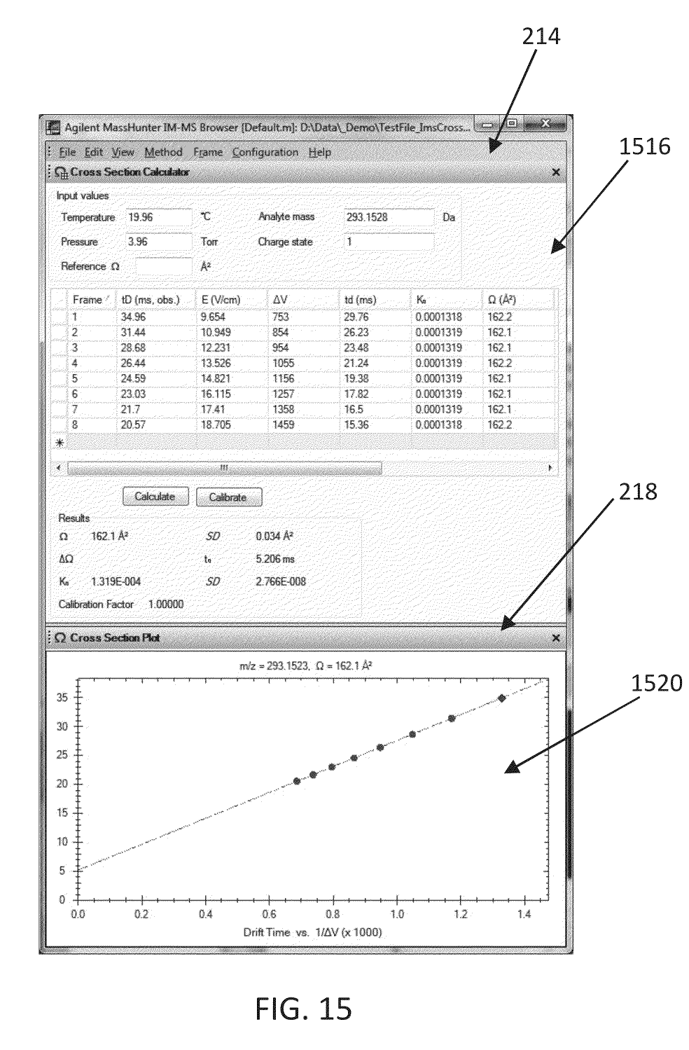

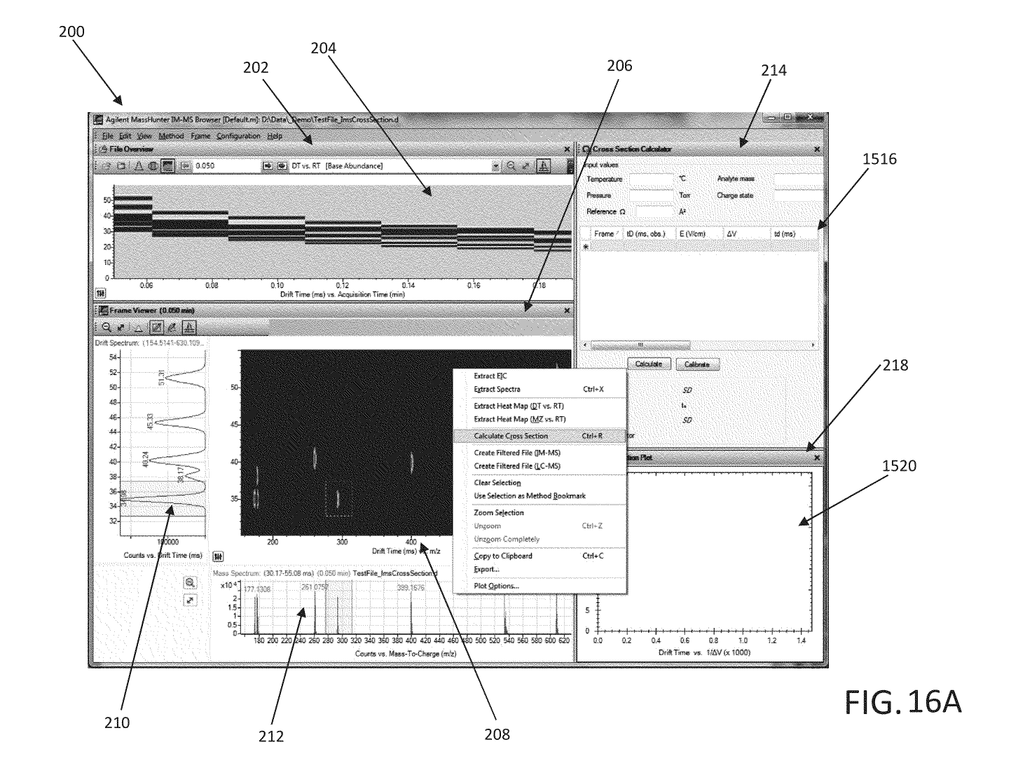

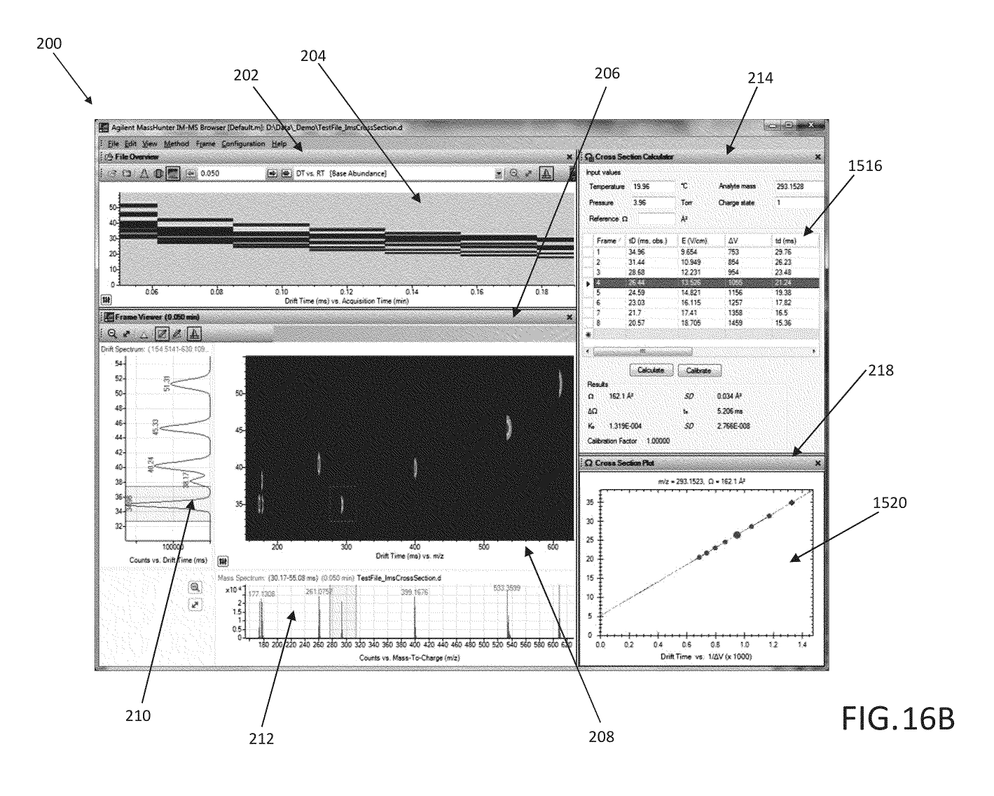

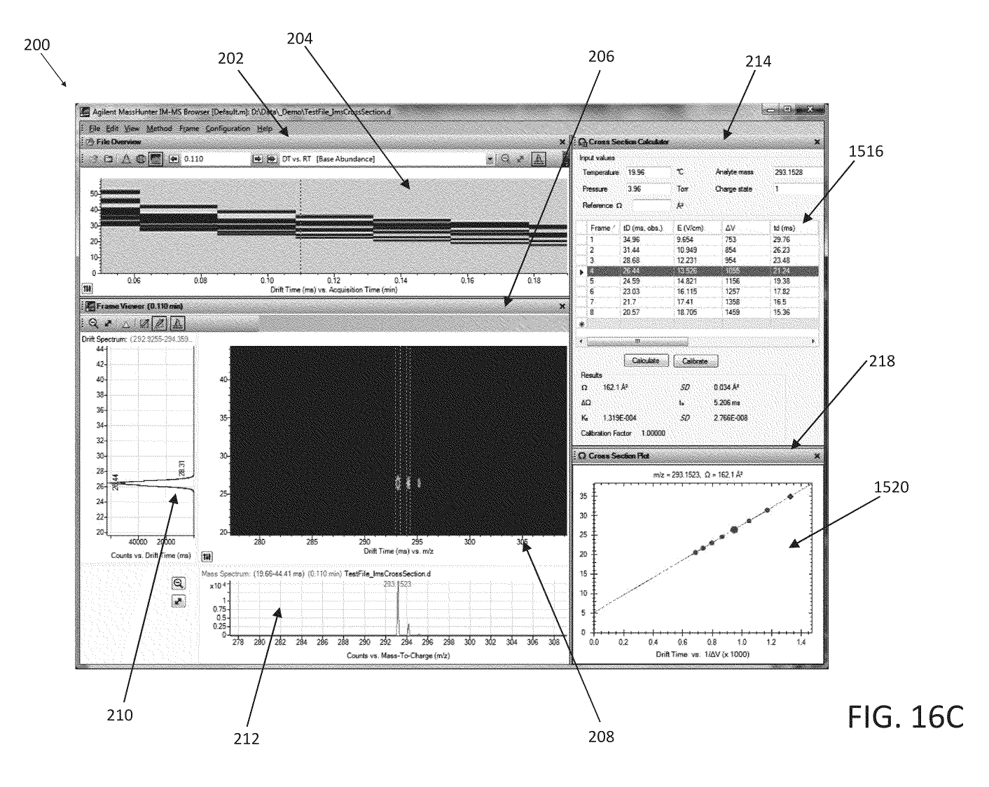

In some embodiments, the user interface provides a tool or module for calculating collisional cross-section (CCS) values (i.e., a cross-section calculator interface, or “Cross Section Calculator”), and optionally may further generate a graph plotting values utilized in the CCS calculation (i.e., a Cross Section Plot), as illustrated in FIGS. 15 to 16C. The traditional process involves measuring the observed ion drift time, t_{D} (ms) of an ion at several different drift field strengths, E (V/cm), plotting t_{D} versus 1/E, and extrapolating to get the drift time intercept, t₀. This is a measure of the time the ion spends between the exit of the drift region and the ion detector, and is subtracted from the observed drift times t_{D} to get corrected drift times, t_{d} (ms). The corrected drift times t_{d} along with other measured data can then be used in the Mason-Schamp equation to compute the average cross section (in square Angstroms, Å²).

FIG. 15 is an example of the third display area 214 and the fourth display area 218, including examples of a cross-section calculator region 1516 and a cross-section plot region 1520, respectively. For example, the user may have switched the third display area 214 from one including the custom spectra region 216 (e.g., FIGS. 2, 14A and 14B) to another including the cross-section calculator region 1516. As shown, the user may manually enter all of the variables necessary for calculating CCS for an ion of interest (m/z=293.1528 in the illustrated example), including a set of observed drift times t_{D} and drift field strengths E. The Cross Section Calculator will then perform the linear regression to find the drift time intercept t₀ as well as performing the rest of the calculations such as the average cross section, S2, as shown in the cross-section calculator region 1516. Optionally, the user interface may also present a plot of resulting data, such as drift time versus 1/AV (×1000).

Alternatively or additionally to the process described above in conjunction with FIG. 15, in some embodiments the user interface may implement an algorithm that automatically extracts all data required for calculating CCS from a properly acquired data file, thereby saving a significant amount of time involved in manual extraction and data entry. FIG. 16A is an example of the screen display 200, illustrating an example of the first display area 202, the second display area 206, the third display area 214, and the fourth display area 218. In this example, the first display area 202 reflects the shift in drift time for the set of ions at each different drift time. The user may select an ion of interest, for example by drawing a region enclosing the ion in the map of the second display area 206 (as indicated by a dotted box in FIG. 16A), and then select a “Calculate Cross Section” command from, for example, a context menu. The resulting data and optional plot of drift time versus 1/ΔAV (×1000) may then be presented in the third display area 214 and the fourth display area 218, as illustrated in FIG. 16B, which is similar to the content shown in FIG. 15.

The data displayed in the third display area 214 and the fourth display area 218 may be dynamically linked to each other, as well as to data in one or more of the other display areas. For example, as illustrated in FIG. 16B, selecting a row of data in the third display area 214 (frame 4 in the table, as indicated by highlighting) automatically highlights the corresponding data point in the plot in the fourth display area 218, as indicated by the corresponding data point being redrawn larger than the other data points in the plot. Highlighting a data point may be done in other ways such as, for example, changing its color, changing its shape, pulsating it, etc. The data selection process is symmetrical, such that selecting a data point in the plot in the fourth display area 218 (e.g., by clicking on the data point) will render the selected data point larger and automatically highlight the corresponding data row in the third display area 214.

In some embodiments, the user interface provides a “Go to bookmark” command in conjunction with cross-section calculations similar to that described above in conjunction with working with custom spectra. The “Go to bookmark” command may, for example, be invoked via a context menu such as by right-clicking in either the third display area 214 or the fourth display area 218. FIG. 16C is an example of the screen display 200 similar to FIG. 16B in which the same data point (Frame 4) has been selected, illustrating the result of executing the “Go to bookmark” command. The second display area 206 now displays the data for the frame from which the point was extracted, along with the m/z range(s) utilized to extract the drift spectrum and the drift spectrum itself just as utilized by the algorithm.

Methods for displaying multi-dimensional spectrometric data such as described above and illustrated in the Figures may be performed (carried out), for example, in a system that includes a processor and a memory as may be embodied in, for example, a computing device communicating with a user input device and a user output device. In some embodiments, the system for displaying multi-dimensional spectrometric data (or an associated computing device) may be considered as including the user input device and/or the user output device. An IMS-MS system such as described above and illustrated in FIG. 1A may include, or be part of, or communicate with a system for displaying multi-dimensional spectrometric data. One or more functions, operations or steps associated with a given method may be implemented by hardware and/or software, including appropriate machine-executable instructions as may be stored on a computer storage medium. The computer storage medium may be interfaced with (e.g., loaded into) and readable by a computing device, which may be a component of (or at least in communication with) a suitable electronic processor-based device or system such as, for example, the computing device 118 schematically illustrated in FIGS. 1A and 1B. In the present context, the term “perform” or “carry out” encompasses actions such as controlling and/or signal or data transmission. For example, the computing device 118 or a processor thereof may perform a method step by controlling another component involved in performing the method step. Performing or controlling may involve making calculations, or sending and/or receiving signals (e.g., control signals, instructions, measurement signals, parameter values, data, etc.).

### EXEMPLARY EMBODIMENTS

Exemplary embodiments provided in accordance with the presently disclosed subject matter include, but are not limited to, the following:

1. A method for displaying and navigating multi-dimensional spectrometric data, the method comprising: receiving ion mobility drift spectral data and mass spectral data; displaying, in a display comprising a plurality of panes, a first ion data plot of abundance versus first data, wherein the first data spans a range in one or more dimensions other than abundance, and wherein the first ion data plot is displayed in a first pane of the display; displaying, in a second pane of the display, a second ion data plot of abundance versus second data, wherein the second data spans a range in one or more dimensions other than abundance; receiving a user selection of a data range in one or more of the dimensions currently displayed in at least one of the panes; and in response to the user selection, displaying a third ion data plot of abundance versus third data, wherein the third data spans a range in one or more dimensions other than abundance, and wherein the third data is restricted to the selected data range or is filtered based on the selected data range.

2. The method of embodiment 1, wherein the third ion data plot is displayed in the first pane, in the second pane, or in another pane different from the first pane and the second pane.

3. The method of embodiment 1 or 2, wherein displaying the third ion data plot comprises overlaying the third ion data plot on the first ion data plot, or on the second ion data plot.

4. The method of embodiment 1 or 2, wherein displaying the third ion data plot comprises replacing the first ion data plot in the first pane with the third ion data plot, or replacing the second ion data plot in the second pane with the third ion data plot.

5. The method of any of the preceding embodiments, wherein at least one of the first ion data plot, the second ion data plot, and the third ion data plot is selected from the group consisting of: a chromatogram plotting abundance versus acquisition time; a drift spectrum plotting abundance versus drift time; a mass spectrum plotting abundance versus m/z ratio; a map plotting abundance versus drift time versus acquisition time; a map plotting abundance versus m/z ratio versus acquisition time; and a map plotting abundance versus drift time versus m/z ratio.

6. The method of embodiment 1 or 5, wherein: the first ion data plot is an existing chromatogram and the first data comprises acquisition time; the selected data range comprises a one dimensional range of acquisition time currently displayed in the existing chromatogram or a two dimensional range of abundance and acquisition time currently displayed in the existing chromatogram; the third data comprises acquisition time; and the third ion data plot is a new chromatogram displaying acquisition time limited to the selected range of acquisition time.

7. The method of embodiment 1 or 5, wherein: the first ion data plot is an existing chromatogram and the first data comprises acquisition time; the second data plot is a drift spectrum or a mass spectrum, and the second data correspondingly comprises drift time or m/z ratio; the selected data range is a range of drift time or m/z ratio currently displayed in the second ion data plot; the third data comprises acquisition time; and the third ion data plot is a new chromatogram displaying abundance filtered according to the selected range of drift time or m/z ratio.

8. The method of embodiment 1 or 5, wherein: the first ion data plot is an existing chromatogram and the first data comprises acquisition time; the second data plot is a drift spectrum, and the second data comprises drift time; and further comprising: displaying, in a third pane of the display, a mass spectrum plotting abundance versus m/z ratio, wherein: the selected data range is a selected range of drift time currently displayed in the drift spectrum, and a selected range of m/z ratio currently displayed in the mass spectrum; the third data comprises acquisition time; and the third ion data plot is a new chromatogram displaying abundance filtered according to the selected range of drift time and the selected range of m/z ratio.

9. The method of embodiment 1 or 5, wherein: the first ion data plot is an existing chromatogram and the first data comprises acquisition time; the second data plot is a map plotting abundance versus second data dimensions of drift time and m/z ratio; the selected data range is a selected range of drift time and a selected range of m/z ratio currently displayed in the map; the third data comprises acquisition time; and the third ion data plot is a new chromatogram displaying abundance filtered according to the selected range of drift time and the selected range of m/z ratio.

10. The method of any of embodiments 6 to 9, wherein displaying the new chromatogram comprises replacing the existing chromatogram in the first pane with the new chromatogram, overlaying the new chromatogram on the existing chromatogram, or displaying the new chromatogram in a pane different from the first pane.

11. A method for displaying and navigating multi-dimensional spectrometric data, the method comprising: receiving ion mobility drift spectral data and mass spectral data; displaying, in a display comprising a plurality of panes, a chromatogram plotting abundance versus acquisition time, wherein the chromatogram is displayed in a first pane of the display; displaying, in a second pane of the display, a map plotting abundance versus drift time versus m/z ratio; receiving a user selection of a range of the acquisition time currently displayed in the chromatogram; and in response to the user selection, displaying a new map plotting abundance versus drift time versus m/z ratio, wherein the new map displays abundance, drift time, and m/z ratio over respective ranges that correspond to the selected range of acquisition time.

12. The method of embodiment 11, wherein displaying the new map comprises replacing the current map in the second pane with the new map, or displaying the new map in a pane different from the second pane.

13. The method of embodiment 11, comprising displaying, in the second pane or in one or more different panes, a drift spectrum and a mass spectrum; and, in response to the user selection, displaying a new drift spectrum that displays abundance summed over the selected range of acquisition time and over all m/z values, and a new mass spectrum that displays abundance summed over the selected range of acquisition time and over all drift times.

14. The method of embodiment 13, wherein displaying the new drift spectrum and the new mass spectrum comprises one or more of the following: replacing the current drift spectrum with the new drift spectrum; displaying the new drift spectrum in a pane different from the pane in which the current drift spectrum is displayed; replacing the current mass spectrum with the new mass spectrum; or displaying the new mass spectrum in a pane different from the pane in which the current mass spectrum is displayed.

15. A method for displaying and navigating multi-dimensional spectrometric data, the method comprising: receiving ion mobility drift spectral data and mass spectral data; displaying, in a display comprising a plurality of panes, an existing map plotting abundance versus drift time versus m/z ratio, wherein the map is displayed in a first pane of the display; displaying, in a second pane of the display, a drift spectrum; displaying, in a third pane of the display, a mass spectrum; receiving a user selection of a range of drift time currently displayed in the map or in the drift spectrum, and/or a range of m/z ratio currently displayed in the map or in the mass spectrum, or ranges of both drift time and m/z ratio currently displayed in the map; and in response to the user selection, displaying one or more of the following: a new map displaying drift time limited to the selected range of drift time and m/z ratio limited to the selected range of m/z ratio; a new drift spectrum displaying drift time limited to the selected range of drift time; and a new mass spectrum displaying m/z ratio limited to the selected range of m/z ratio.

16. The method of embodiment 15, wherein displaying the new map comprises replacing the existing map in the first pane with the new map, or displaying the new map in a pane different from the first pane.

17. The method of embodiment 15, wherein displaying the new drift spectrum comprises replacing the existing drift spectrum in the second pane with the new drift spectrum, overlaying the new drift spectrum on the existing drift spectrum, or displaying the new drift spectrum in a pane different from the second pane.

18. The method of embodiment 15, wherein displaying the new mass spectrum comprises replacing the existing mass spectrum in the third pane with the new mass spectrum, overlaying the new mass spectrum on the existing mass spectrum, or displaying the new mass spectrum in a pane different from the third pane.

19. The method of embodiment 15, comprising adding a copy of the new drift spectrum or the new mass spectrum to a plurality of drift spectra or mass spectra displayed in a fourth pane.

20. The method of embodiment 19, comprising receiving a user selection of one of the drift spectra or mass spectra displayed in a fourth pane; and, in response to the user selection, displaying the map in the first pane, the drift spectrum in the second pane, and the mass spectrum in the third pane according to the same range of drift time or m/z ratio displayed in the selected drift spectrum or mass spectrum in the fourth pane.

21. A method for displaying and navigating multi-dimensional spectrometric data, the method comprising: receiving ion mobility drift spectral data and mass spectral data; displaying, in a display comprising a plurality of regions, a map of abundance versus drift time versus mass-to-charge (m/z) ratio, wherein the map is displayed in a first region of the display; displaying, in a second region of the display, a dynamic drift spectrum of signal intensity versus drift time, wherein the drift time in the dynamic drift spectrum is plotted over a drift range matching a drift range over which the drift time in the map is plotted; displaying, in a third region of the display, a dynamic mass spectrum of signal intensity versus m/z ratio, wherein the m/z ratio in the dynamic mass spectrum is plotted over an m/z range matching an m/z range over which the m/z ratio in the map is plotted; receiving a user input of a change to be made to a current range of selected data displayed in a selected region; and in response to the user input, changing the range and displaying the selected data according to the changed range in one or more regions.

22. The method of embodiment 21, wherein the signal intensity plotted in the dynamic drift spectrum corresponds to abundance summed over the m/z range plotted in the map, and the signal intensity plotted in the dynamic mass spectrum corresponds to abundance summed over the drift range plotted in the map.

23. The method of embodiment 21 or 22, wherein the changed range is selected from the group consisting of: a single value selected from the current range, a range narrower than the current range, a range broader than the current range, a range shifted upward relative to the current range, and a range shifted downward relative to the current range.

24. The method of any of embodiments 21 to 23, wherein the selected data comprises drift time data, m/z ratio data, or both drift time data and m/z ratio data.

25. The method of any of embodiments 21 to 24, comprising adding a copy of the display of the selected data according to the changed range in a fourth region separate from the first region, the second region, and the third region.

26. The method of any of embodiments 21 to 25, comprising, in response to changing the range of the selected data, dynamically changing a current range of corresponding data displayed in one or more of the other regions that contain the corresponding data, and displaying the corresponding data according to the changed range in one or more of those regions.

27. The method of embodiment 26, wherein the selected region is the first region, and changing the range of the selected data is selected from the group consisting of: changing a range of drift time data displayed in the first region, wherein the corresponding data is drift time data displayed in the second region; changing a range of m/z ratio data displayed in the first region, wherein the corresponding data is m/z ratio data displayed in the third region; and changing a drift range of drift time data and a mass range of m/z ratio data displayed in the first region, wherein the corresponding data is drift time data displayed in the second region and m/z ratio data displayed in the third region, and wherein the drift time data displayed in the second region is displayed according to the changed drift range and the m/z ratio data displayed in the third region is displayed according to the changed mass range.

28. The method of embodiment 26, wherein the selected region is selected from the group consisting of: the second region, wherein changing the range of the selected data comprises changing a range of drift time data displayed in the second region, wherein a range of drift time data displayed in the first region is dynamically changed; the third region, wherein changing the range of the selected data comprises changing a range of m/z ratio data displayed in the third region, wherein a range of m/z ratio data displayed in the first region is dynamically changed; and the second region and the third region, wherein changing the range of the selected data comprises changing a range of drift time data displayed in the second region and changing a range of m/z ratio data displayed in the third region, wherein drift time data and m/z ratio data displayed in the first region are dynamically changed.

29. The method of any of embodiments 21 to 28, wherein the map and the dynamic drift spectrum comprise respective drift time axes displayed in parallel with each other, and the map and the dynamic mass spectrum comprise respective m/z ratio axes displayed in parallel with each other.

30. The method of any of embodiments 21 to 29, comprising displaying abundance values in the map according to a color-coding in which different abundance values are displayed as different colors.

31. The method of any of embodiments 21 to 30, comprising, in response to receiving the user input, displaying in the selected region a representation of the range of the selected data to be changed, and displaying a corresponding representation of the range to be changed in one or more other regions that contain corresponding data.

32. The method of embodiment 31, wherein the selected data is selected from the group consisting of: drift time data; m/z ratio data; and both drift time data and m/z ratio data.

33. The method of embodiment 31 or 32, wherein the representation of the range of the selected data to be changed comprises one or more lines displayed in the selected region, the one or more lines representing one or more values in the range, and the corresponding representation comprises a projection of the one or more lines in the one or more other regions.

34. The method of embodiment 31 or 32, wherein the selected region is the first region, and the representation of the range of the selected data to be changed comprises a polygon comprising a first pair of parallel lines and a second pair of parallel lines, and the corresponding representation comprises a projection of the first pair of parallel lines in the second region and a projection of the second pair of parallel lines in the third region.

35. The method of embodiment 31 or 32, wherein the selected region is the second region and the third region, and the representation of the range of the selected data to be changed comprises a first pair of parallel lines in the second region and a second pair of parallel lines in the third region, and the corresponding representation comprises a polygon in the first region bounded by a projection of the first pair of parallel lines and a projection of the second pair of parallel lines.

36. The method of embodiment 31 or 32, wherein the selected region is the first region, and the representation of the range of the selected data to be changed comprises an irregularly shaped polygon or a curved shape.

37. The method of any of embodiments 21 to 36, wherein changing the range of the selected data comprises generating a custom spectrum based on the changed range, the custom spectrum being selected from the group consisting of: a custom drift spectrum; a custom mass spectrum; and both a custom drift spectrum and a custom mass spectrum.

38. The method of embodiment 37, wherein generating a custom spectrum is selected from the group consisting of: selecting a range of m/z ratio data displayed in the dynamic mass spectrum or in the map, and generating a custom drift spectrum based on the selected range of m/z ratio data; selecting a range of drift data displayed in the dynamic drift spectrum or in the map, and generating a custom mass spectrum based on the selected range of drift data; and both of the foregoing.

39. The method of embodiment 37 or 38, wherein displaying the selected data according to the change range comprises displaying the custom spectrum at a location selected from the group consisting of: displaying the custom spectrum as a custom drift spectrum that replaces the drift spectrum currently displayed in the second region, wherein the currently displayed drift spectrum is the dynamic drift spectrum or a previously generated custom drift spectrum; displaying the custom spectrum as a custom drift spectrum that overlays the dynamic drift spectrum displayed in the second region; displaying the custom spectrum as a custom drift spectrum in a region of the display different from the first region, the second region, and the third region; displaying the custom spectrum as a custom mass spectrum that replaces the mass spectrum currently displayed in the third region, wherein the currently displayed mass spectrum is the dynamic mass spectrum or a previously generated custom mass spectrum; displaying the custom spectrum as a custom mass spectrum that overlays the dynamic mass spectrum displayed in the third region; displaying the custom spectrum as a custom mass spectrum in a region of the display different from the first region, the second region, and the third region; and a combination of two or more of the foregoing.

40. The method of embodiment 37 or 38, comprising displaying the custom spectrum in a fourth region separate from the first region, the second region, and the third region.

41. The method of embodiment 40, comprising, while displaying the custom spectrum in the fourth region, displaying at least one of the map in the first region, the drift spectrum in the second region, and the mass spectrum in the third region according to a previous range, wherein the previous range is a range displayed before changing the range on which the custom spectrum is based.

42. The method of embodiment 40, comprising, while displaying the custom spectrum in the fourth region, displaying at least one of the map in the first region, the drift spectrum in the second region, and the mass spectrum in the third region according to the changed range on which the custom spectrum is based.

43. The method of embodiment 40, wherein a plurality of custom spectra are displayed in the fourth region, each custom spectrum based on a respective changed range, and further comprising: selecting one of the custom spectra; and displaying at least one of the map in the first region, the drift spectrum in the second region, and the mass spectrum in the third region according to the changed range on which the selected custom spectrum is based.

44. The method of embodiment 37, comprising: generating a plurality of custom spectra by repeating, one or more times, the steps of: receiving a user input of a change to be made to a current range of selected data displayed in a selected region; in response to the user input, changing the range and displaying the selected data according to the changed range in one or more regions; and generating a custom spectrum based on the changed range; and displaying the plurality of custom spectra in a fourth region separate from the first region, the second region, and the third region.

45. The method of embodiment 44, wherein displaying the plurality of custom spectra comprises displaying the custom spectra in the fourth region in an arrangement selected from the group consisting of: displaying each custom spectrum separately from the other custom spectra, wherein each custom spectrum includes a respective drift time axis and a signal intensity axis; and overlaying the custom spectra together such that all of the custom spectra are plotted with reference to a single drift time axis and a single signal intensity axis.

46. The method of any of embodiments 21 to 45, comprising displaying, in an acquisition time region of the display, an ion measurement graph plotting ion measurement data as a function of acquisition time.

47. The method of embodiment 46, wherein the ion measurement data is selected from the group consisting of total ion signal intensity, extracted ion signal intensity, drift time, and m/z ratio.

48. The method of embodiment 46 or 47, comprising receiving a user selection of a range of the acquisition time displayed in the ion measurement graph and, in response to the user selection, displaying at least one of the map in the first region, the drift spectrum in the second region, and the mass spectrum in the third region according to the selected range of the acquisition time.

49. The method of embodiment 46, comprising displaying the ion measurement graph as an acquisition time map of abundance versus drift time versus acquisition time.

50. The method of embodiment 49, comprising displaying abundance values in the acquisition time map according to a color-coding in which different abundance values are displayed as different colors.

51. The method of any of embodiments 21 to 50, comprising displaying a collisional cross-section calculator interface in a cross-section calculator region.

52. The method of embodiment 51, comprising receiving a user input of data regarding a selected ion and, in response to the user input, displaying the data regarding the selected ion in the cross-section calculator region.

53. The method of embodiment 52, comprising receiving the user input of data regarding the selected ion in the cross-section calculator region.

54. The method of embodiment 52, comprising receiving the user input of data regarding the selected ion in a selected one of the regions of the second display area, and dynamically extracting the data regarding the selected ion for display in the cross-section calculator region.

55. The method of embodiment 52, further comprising, in response to the user input, calculating a collisional cross-section of the selected ion and displaying data regarding the calculated collisional cross-section in the cross-section calculator region.

56. The method of embodiment 55, comprising displaying at least some of the data regarding the calculated collisional cross-section in a cross-section plot region.

57. The method of embodiment 56, comprising receiving a user input of a selected data point of the data regarding the selected ion and, in response to the user input of the selected data point, displaying in the cross-section calculator region a representation of the selected data point, and displaying in the cross-section plot region a representation of a corresponding data point of the data regarding the calculated collisional cross-section.

58. The method of embodiment 56, comprising receiving a user input of a selected data point of the data regarding the calculated collisional cross-section and, in response to the user input of the selected data point, displaying in the calculated collisional cross-section a representation of the selected data point, and displaying in the cross-section calculator region a representation of the corresponding data point of the data regarding the selected ion.

59. The method of embodiment 55, comprising receiving a user input of a selected data point of the data regarding the selected ion and, in response to the user input of the selected data point, displaying at least one of the map in the first region, the drift spectrum in the second region, and the mass spectrum in the third region according to data corresponding to the selected data point.

60. A method for displaying and navigating multi-dimensional spectrometric data, the method comprising: at a computing device comprising a processor and a memory: receiving ion mobility drift spectral data and mass spectral data; in a display comprising a plurality of regions, displaying in a first region a first ion data plot of abundance versus first data; displaying, in a second region of the display, a second ion data plot of abundance versus second data, wherein the second data are a dimension of data different from the first data; receiving a user selection of a data range of data currently displayed in a selected region of the display, wherein the selected region is at least one of the first region, the second region, and a region of the display other than the first region and the second region; and in response to the user selection, displaying a third ion data plot of abundance versus third data in at least one of the regions of the display, wherein the third data spans a data range corresponding to the selected data range.

61. The method of embodiment 60, wherein the third data is selected from the group consisting of: the third data is the same dimension as the data of the selected data range, and the selected data range is a range narrower than, broader than, or shifted from the data currently displayed in the second region; and the third data is a dimension different than the data of the selected data range, and the data range spanned by the third data is filtered to include only data corresponding to the selected data range.

62. The method of embodiment 60 or 61, wherein displaying the third ion data plot comprises at least one of: displaying the third ion data plot in the first region; displaying the third ion data plot in the second region; displaying the third ion data plot in a third region of the display; overlaying the third ion data plot on the first ion data plot; overlaying the third ion data plot on the second ion data plot; replacing the first ion data plot in the first region with the third ion data plot;

replacing the second ion data plot in the second region with the third ion data plot.

63. The method of any of embodiments 60to 62, wherein at least one of the first ion data plot, the second ion data plot, and the third ion data plot is selected from the group consisting of: a chromatogram plotting abundance versus acquisition time; a drift spectrum plotting abundance versus drift time; a mass spectrum plotting abundance versus m/z ratio; a map plotting abundance versus drift time versus acquisition time; a map plotting abundance versus m/z ratio versus acquisition time; a map plotting abundance versus drift time versus m/z ratio; a total ion current chromatogram; an extracted ion current chromatogram; and a frame selector view.

64. The method of embodiment 60, wherein: the first ion data plot is a chromatogram or map and the first data comprise acquisition time; the selected data range comprises a range of acquisition time currently displayed in the chromatogram or map; the third data comprise acquisition time; and the third ion data plot is a new chromatogram or map displaying acquisition time limited to the selected range of acquisition time.

65. The method of embodiment 60, wherein: the first ion data plot is a chromatogram or map and the first data comprise acquisition time; the first ion data plot is a chromatogram or map and the first data comprise acquisition time; the second data plot is a drift spectrum or a mass spectrum, and the second data correspondingly comprise drift time or m/z ratio; the selected data range is a range of drift time or m/z ratio currently displayed in the second ion data plot; the third data comprise acquisition time; and the third ion data plot is a new chromatogram or map displaying abundance filtered according to the selected range of drift time or m/z ratio.

66. The method of embodiment 60, wherein the first ion data plot is a chromatogram or map and the first data comprise acquisition time, and the second data plot is a drift spectrum and the second data comprise drift time, and further comprising: displaying, in a third region of the display, a mass spectrum plotting abundance versus m/z ratio, wherein: the selected data range is a selected range of drift time currently displayed in the drift spectrum, and a selected range of m/z ratio currently displayed in the mass spectrum; the third data comprises acquisition time; and the third ion data plot is a new chromatogram or map displaying abundance filtered according to the selected range of drift time and the selected range of m/z ratio.

67. The method of embodiment 60, wherein: the first ion data plot is a chromatogram or map and the first data comprise acquisition time; the second data plot is a map plotting abundance versus drift time versus m/z ratio; the selected data range is a selected range of drift time and a selected range of m/z ratio currently displayed in the map; the third data comprise acquisition time; and the third ion data plot is a new chromatogram or map displaying abundance filtered according to the selected range of drift time and the selected range of m/z ratio.

68. The method of embodiment 60, wherein: the first ion data plot is a chromatogram or map and the first data comprise acquisition time; the second data plot is a map plotting abundance versus drift time versus m/z ratio; the selected data range is a selected range of acquisition time currently displayed in the chromatogram; and the third ion data plot is a new map displaying abundance versus drift time versus m/z ratio over respective ranges corresponding to the selected range of acquisition time.

69. The method of embodiment 68, comprising: displaying, in one or more regions of the display, a drift spectrum, a mass spectrum, or both a drift spectrum and a mass spectrum; and in response to the user selection, displaying a new drift spectrum that displays abundance summed over the selected range of acquisition time and over all m/z values, or a new mass spectrum that displays abundance summed over the selected range of acquisition time and over all drift times, or both a new drift spectrum and a new mass spectrum.

70. The method of embodiment 60, wherein the first ion data plot is a map plotting abundance versus drift time versus m/z ratio, and the second data plot is a drift spectrum and the second data comprise drift time, and further comprising: displaying, in a third region of the display, a mass spectrum plotting abundance versus m/z ratio, wherein: the selected data range is selected from the group consisting of: a range of drift time currently displayed in the map or in the drift spectrum; a range of m/z ratio currently displayed in the map or in the mass spectrum; and both of the foregoing; and the third ion data plot is selected from the group consisting of: a new map displaying drift time limited to the selected range of drift time and m/z ratio limited to the selected range of m/z ratio; a new drift spectrum displaying drift time limited to the selected range of drift time; a new mass spectrum displaying m/z ratio limited to the selected range of m/z ratio; and a combination of two or more of the foregoing.

71. The method of embodiment 60, wherein the third ion data plot is an extracted drift spectrum or an extracted mass spectrum, and further comprising copying the third ion data plot to memory or for display in a fourth region of the display.

72. The method of embodiment 71, wherein the fourth region comprises a plurality of drift spectra or mass spectra, and further comprising receiving a user selection of one of the drift spectra or mass spectra displayed in a fourth region and, in response to the user selection, displaying the map in the first region, the drift spectrum in the second region, and the mass spectrum in the third region according to the same range of drift time or m/z ratio displayed in the selected drift spectrum or mass spectrum in the fourth region.

73. The method of any of embodiments 60 to 72, wherein the selected data range is selected from the group consisting of: a single value selected from the data currently displayed in the selected region; a range narrower than the range of data currently displayed in the selected region; a range broader than the range of data currently displayed in the selected region; a range shifted upward relative to the range of data currently displayed in the selected region; and a range shifted downward relative to the range of data currently displayed in the selected region.

74. The method of any of embodiments 60 to 73, comprising, in response to the user selection, displaying in the selected region a representation of the selected data range, and displaying a corresponding representation of the selected data range in one or more other regions of the display that contain corresponding data.

75. The method of embodiment 74, comprising one of the following: wherein the representation of the selected data range comprises one or more lines displayed in the selected region, the one or more lines representing one or more values in the selected data range, and the corresponding representation comprises a projection of the one or more lines in the one or more other regions; wherein the one or more other regions comprise a first other region and a second other region, the representation of the selected data range comprises a polygon comprising a first pair of parallel lines and a second pair of parallel lines displayed in the selected region, the second pair of parallel lines being orthogonal to the first pair of parallel lines, and the corresponding representation comprises a projection of the first pair of parallel lines in the first other region and a projection of the second pair of parallel lines in the second other region; wherein the selected region comprises a first selected region and a second selected region, and the representation of the selected data range comprises a first pair of parallel lines displayed in the first selected region and a second pair of parallel lines displayed in the second selected region, the corresponding representation comprises a polygon in the in the one or more other regions, and the polygon is bounded by a projection of the first pair of parallel lines and a projection of the second pair of parallel lines; wherein the representation of the selected data range comprises an irregularly shaped polygon or a curved shape.

76. The method of any of embodiments 60 to 75, comprising displaying a collisional cross-section calculator interface in a cross-section calculator region of the display.

77. The method of embodiment 76, comprising receiving a user input of data regarding a selected ion and, in response to the user input, displaying the data regarding the selected ion in the cross-section calculator region.

78. The method of embodiment 77, comprising one of the following: receiving the user input of data regarding the selected ion in a region of the display other than the cross-section calculator region, and extracting the data regarding the selected ion for display in the cross-section calculator region; in response to the user input, calculating a collisional cross-section of the selected ion and displaying data regarding the calculated collisional cross-section in the cross-section calculator region; in response to the user input, calculating a collisional cross-section of the selected ion and displaying data regarding the calculated collisional cross-section in the cross-section calculator region, and displaying at least some of the data regarding the calculated collisional cross-section in a cross-section plot region; in response to the user input, calculating a collisional cross-section of the selected ion and displaying data regarding the calculated collisional cross-section in the cross-section calculator region, and receiving a user selection of a data point currently displayed in the cross-section calculator region or a corresponding data point currently displayed in the cross-section plot region, and displaying in the cross-section calculator region a highlighted representation of the selected data point, and displaying in the cross-section plot region a highlighted representation of the corresponding data point; in response to the user input, calculating a collisional cross-section of the selected ion and displaying data regarding the calculated collisional cross-section in the cross-section calculator region, and receiving a user selection of a data point currently displayed in the cross-section calculator region or a corresponding data point currently displayed in the cross-section plot region, and modifying the display of one of the ion data plots currently displayed outside cross-section calculator interface based on the data point selected.

79. The method of any of embodiments 1 to 78, comprising, before receiving the ion mobility drift spectral data and the mass spectral data, acquiring the ion mobility drift spectral data and the mass spectral data by processing a sample in an ion mobility spectrometry-mass spectrometry system.

80. A system for displaying and navigating multi-dimensional spectrometric data, the system comprising: at least a processor and a memory configured for performing all or part of the method of any of the preceding embodiments.

81. The system of embodiment 80, comprising a user output device, a user input device, or both a user output device and a user input device.

82. The system of embodiment 80 or 81, comprising an ion detector configured for transmitting ion measurement signals to the processor.

83. The system of embodiment 82, comprising an ion mobility spectrometer and a mass spectrometer communicating with the ion detector.

84. An ion mobility spectrometry-mass spectrometry (IMS-MS) system comprising at least a processor and a memory configured for performing all or part of the method of any of the preceding embodiments.

85. A computer-readable storage medium comprising instructions for performing all or part of the method of any of the preceding embodiments.

86. A system comprising the computer-readable storage medium of embodiment 85.

As used herein, an “interface” or “user interface” is generally a system by which users interact with a computing device. An interface may include an input (e.g., a user input device) for allowing users to manipulate a computing device, and may include an output (e.g., a user output device) for allowing the system to present information and/or data, indicate the effects of the user's manipulation, etc. An example of an interface on a computing device includes a graphical user interface (GUI) that allows users to interact with programs in more ways than typing. A GUI typically may offer display objects, and visual indicators, as opposed to (or in addition to) text-based interfaces, typed command labels or text navigation to represent information and actions available to a user. For example, an interface may be a display window or display object, which is selectable by a user of a computing device for interaction. The display object may be displayed on a display screen of a computing device and may be selected by and interacted with by a user using the interface. In one non-limiting example, the display of the computing device may be a touch screen, which may display the display icon. The user may depress the area of the touch screen at which the display icon is displayed for selecting the display icon. In another example, the user may use any other suitable interface of a computing device, such as a keypad, to select the display icon or display object. For example, the user may use a track ball or arrow keys for moving a cursor to highlight and select the display object.

It will be understood that one or more of the processes, sub-processes, and process steps described herein may be performed by hardware, firmware, software, or a combination of two or more of the foregoing, on one or more electronic or digitally-controlled devices. The software may reside in a software memory (not shown) in a suitable electronic processing component or system such as, for example, the computing device 118 schematically depicted in FIGS. 1A and 1B. The software memory may include an ordered listing of executable instructions for implementing logical functions (that is, “logic” that may be implemented in digital form such as digital circuitry or source code, or in analog form such as an analog source such as an analog electrical, sound, or video signal). The instructions may be executed within a processing module, which includes, for example, one or more microprocessors, general purpose processors, combinations of processors, digital signal processors (DSPs), or application specific integrated circuits (ASICs). Further, the schematic diagrams describe a logical division of functions having physical (hardware and/or software) implementations that are not limited by architecture or the physical layout of the functions. The examples of systems described herein may be implemented in a variety of configurations and operate as hardware/software components in a single hardware/software unit, or in separate hardware/software units.

The executable instructions may be implemented as a computer program product having instructions stored therein which, when executed by a processing module of an electronic system (e.g., the computing device 118 in FIGS. 1A and 1B), direct the electronic system to carry out the instructions. The computer program product may be selectively embodied in any non-transitory computer-readable storage medium for use by or in connection with an instruction execution system, apparatus, or device, such as a electronic computer-based system, processor-containing system, or other system that may selectively fetch the instructions from the instruction execution system, apparatus, or device and execute the instructions. In the context of this disclosure, a computer-readable storage medium is any non-transitory means that may store the program for use by or in connection with the instruction execution system, apparatus, or device. The non-transitory computer-readable storage medium may selectively be, for example, an electronic, magnetic, optical, electromagnetic, infrared, or semiconductor system, apparatus, or device. A non-exhaustive list of more specific examples of non-transitory computer readable media include: an electrical connection having one or more wires (electronic); a portable computer diskette (magnetic); a random access memory (electronic); a read-only memory (electronic); an erasable programmable read only memory such as, for example, flash memory (electronic); a compact disc memory such as, for example, CD-ROM, CD-R, CD-RW (optical); and digital versatile disc memory, i.e., DVD (optical). Note that the non-transitory computer-readable storage medium may even be paper or another suitable medium upon which the program is printed, as the program may be electronically captured via, for instance, optical scanning of the paper or other medium, then compiled, interpreted, or otherwise processed in a suitable manner if necessary, and then stored in a computer memory or machine memory.

It will also be understood that the term “in signal communication” as used herein means that two or more systems, devices, components, modules, or sub-modules are capable of communicating with each other via signals that travel over some type of signal path. The signals may be communication, power, data, or energy signals, which may communicate information, power, or energy from a first system, device, component, module, or sub-module to a second system, device, component, module, or sub-module along a signal path between the first and second system, device, component, module, or sub-module. The signal paths may include physical, electrical, magnetic, electromagnetic, electrochemical, optical, wired, or wireless connections. The signal paths may also include additional systems, devices, components, modules, or sub-modules between the first and second system, device, component, module, or sub-module.

More generally, terms such as “communicate” and “in . . . communication with” (for example, a first component “communicates with” or “is in communication with” a second component) are used herein to indicate a structural, functional, mechanical, electrical, signal, optical, magnetic, electromagnetic, ionic or fluidic relationship between two or more components or elements. As such, the fact that one component is said to communicate with a second component is not intended to exclude the possibility that additional components may be present between, and/or operatively associated or engaged with, the first and second components.

It will be understood that various aspects or details of the invention may be changed without departing from the scope of the invention. Furthermore, the foregoing description is for the purpose of illustration only, and not for the purpose of limitation—the invention being defined by the claims.

What is claimed is:

1. A method for displaying and navigating multi-dimensional spectrometric data, the method comprising:
at a computing device comprising a processor and a memory:
receiving ion mobility drift spectral data and mass spectral data;
in a display comprising a plurality of regions, displaying in a first region a first ion data plot of abundance versus first data;
displaying, in a second region of the display, a second ion data plot of abundance versus second data, wherein the second data are a dimension of data different from the first data;
receiving a user selection of a data range of data currently displayed in a selected region of the display, wherein the selected region is at least one of the first region, the second region, and a region of the display other than the first region and the second region; and
in response to the user selection, displaying a third ion data plot of abundance versus third data in at least one of the regions of the display, wherein the third data spans a data range corresponding to the selected data range.

2. The method of claim 1, wherein the third data is selected from the group consisting of:
the third data is the same dimension as the data of the selected data range, and the selected data range is a range narrower than, broader than, or shifted from the data currently displayed in the second region; and
the third data is a dimension different than the data of the selected data range, and the data range spanned by the third data is filtered to include only data corresponding to the selected data range.

3. The method of claim 1, wherein displaying the third ion data plot comprises at least one of:
displaying the third ion data plot in the first region; displaying the third ion data plot in the second region; displaying the third ion data plot in a third region of the display; overlaying the third ion data plot on the first ion data plot; overlaying the third ion data plot on the second ion data plot; replacing the first ion data plot in the first region with the third ion data plot; replacing the second ion data plot in the second region with the third ion data plot.

4. The method of claim 1, wherein at least one of the first ion data plot, the second ion data plot, and the third ion data plot is selected from the group consisting of: a chromatogram plotting abundance versus acquisition time; a drift spectrum plotting abundance versus drift time; a mass spectrum plotting abundance versus m/z ratio; a map plotting abundance versus drift time versus acquisition time; a map plotting abundance versus m/z ratio versus acquisition time; a map plotting abundance versus drift time versus m/z ratio; a total ion current chromatogram; an extracted ion current chromatogram; and a frame selector view.

5. The method of claim 1, wherein:
the first ion data plot is a chromatogram or map and the first data comprise acquisition time;
the selected data range comprises a range of acquisition time currently displayed in the chromatogram or map;
the third data comprise acquisition time; and
the third ion data plot is a new chromatogram or map displaying acquisition time limited to the selected range of acquisition time.

6. The method of claim 1, wherein:
the first ion data plot is a chromatogram or map and the first data comprise acquisition time;
the second data plot is a drift spectrum or a mass spectrum, and the second data correspondingly comprise drift time or m/z ratio;
the selected data range is a range of drift time or m/z ratio currently displayed in the second ion data plot;
the third data comprise acquisition time; and
the third ion data plot is a new chromatogram or map displaying abundance filtered according to the selected range of drift time or m/z ratio.

7. The method of claim 1, wherein the first ion data plot is a chromatogram or map and the first data comprise acquisition time, and the second data plot is a drift spectrum and the second data comprise drift time, and further comprising:
displaying, in a third region of the display, a mass spectrum plotting abundance versus m/z ratio, wherein:
the selected data range is a selected range of drift time currently displayed in the drift spectrum, and a selected range of m/z ratio currently displayed in the mass spectrum;
the third data comprises acquisition time; and
the third ion data plot is a new chromatogram or map displaying abundance filtered according to the selected range of drift time and the selected range of m/z ratio.

8. The method of claim 1, wherein:
the first ion data plot is a chromatogram or map and the first data comprise acquisition time;
the second data plot is a map plotting abundance versus drift time versus m/z ratio;
the selected data range is a selected range of drift time and a selected range of m/z ratio currently displayed in the map;
the third data comprise acquisition time; and
the third ion data plot is a new chromatogram or map displaying abundance filtered according to the selected range of drift time and the selected range of m/z ratio.

9. The method of claim 1, wherein:
the first ion data plot is a chromatogram or map and the first data comprise acquisition time;
the second data plot is a map plotting abundance versus drift time versus m/z ratio;
the selected data range is a selected range of acquisition time currently displayed in the chromatogram; and
the third ion data plot is a new map displaying abundance versus drift time versus m/z ratio over respective ranges corresponding to the selected range of acquisition time.

10. The method of claim 9, comprising:
displaying, in one or more regions of the display, a drift spectrum, a mass spectrum, or both a drift spectrum and a mass spectrum; and
in response to the user selection, displaying a new drift spectrum that displays abundance summed over the selected range of acquisition time and over all m/z values, or a new mass spectrum that displays abundance summed over the selected range of acquisition time and over all drift times, or both a new drift spectrum and a new mass spectrum.

11. The method of claim 1, wherein the first ion data plot is a map plotting abundance versus drift time versus m/z ratio, and the second data plot is a drift spectrum and the second data comprise drift time, and further comprising:
displaying, in a third region of the display, a mass spectrum plotting abundance versus m/z ratio, wherein:
the selected data range is selected from the group consisting of: a range of drift time currently displayed in the map or in the drift spectrum; a range of m/z ratio currently displayed in the map or in the mass spectrum; and both of the foregoing; and
the third ion data plot is selected from the group consisting of: a new map displaying drift time limited to the selected range of drift time and m/z ratio limited to the selected range of m/z ratio; a new drift spectrum displaying drift time limited to the selected range of drift time; a new mass spectrum displaying m/z ratio limited to the selected range of m/z ratio; and a combination of two or more of the foregoing.

12. The method of claim 1, wherein the third ion data plot is an extracted drift spectrum or an extracted mass spectrum, and further comprising copying the third ion data plot to memory or for display in a fourth region of the display.

13. The method of claim 12, wherein the fourth region comprises a plurality of drift spectra or mass spectra, and further comprising receiving a user selection of one of the drift spectra or mass spectra displayed in a fourth region and, in response to the user selection, displaying the map in the first region, the drift spectrum in the second region, and the mass spectrum in the third region according to the same range of drift time or m/z ratio displayed in the selected drift spectrum or mass spectrum in the fourth region.

14. The method of claim 1, wherein the selected data range is selected from the group consisting of: a single value selected from the data currently displayed in the selected region; a range narrower than the range of data currently displayed in the selected region; a range broader than the range of data currently displayed in the selected region; a range shifted upward relative to the range of data currently displayed in the selected region; and a range shifted downward relative to the range of data currently displayed in the selected region.

15. The method of claim 1, comprising, in response to the user selection, displaying in the selected region a representation of the selected data range, and displaying a corresponding representation of the selected data range in one or more other regions of the display that contain corresponding data.

16. The method of claim 15, comprising one of the following:
wherein the representation of the selected data range comprises one or more lines displayed in the selected region, the one or more lines representing one or more values in the selected data range, and the corresponding representation comprises a projection of the one or more lines in the one or more other regions;
wherein the one or more other regions comprise a first other region and a second other region, the representation of the selected data range comprises a polygon comprising a first pair of parallel lines and a second pair of parallel lines displayed in the selected region, the second pair of parallel lines being orthogonal to the first pair of parallel lines, and the corresponding representation comprises a projection of the first pair of parallel lines in the first other region and a projection of the second pair of parallel lines in the second other region;
wherein the selected region comprises a first selected region and a second selected region, and the representation of the selected data range comprises a first pair of parallel lines displayed in the first selected region and a second pair of parallel lines displayed in the second selected region, the corresponding representation comprises a polygon in the in the one or more other regions, and the polygon is bounded by a projection of the first pair of parallel lines and a projection of the second pair of parallel lines;
wherein the representation of the selected data range comprises an irregularly shaped polygon or a curved shape.

17. The method of claim 1, comprising displaying a collisional cross-section calculator interface in a cross-section calculator region of the display.

18. The method of claim 17, comprising receiving a user input of data regarding a selected ion and, in response to the user input, displaying the data regarding the selected ion in the cross-section calculator region.

19. The method of claim 18, comprising one of the following:
receiving the user input of data regarding the selected ion in a region of the display other than the cross-section calculator region, and extracting the data regarding the selected ion for display in the cross-section calculator region;
in response to the user input, calculating a collisional cross-section of the selected ion and displaying data regarding the calculated collisional cross-section in the cross-section calculator region;
in response to the user input, calculating a collisional cross-section of the selected ion and displaying data regarding the calculated collisional cross-section in the cross-section calculator region, and displaying at least some of the data regarding the calculated collisional cross-section in a cross-section plot region;
in response to the user input, calculating a collisional cross-section of the selected ion and displaying data regarding the calculated collisional cross-section in the cross-section calculator region, and receiving a user selection of a data point currently displayed in the cross-section calculator region or a corresponding data point currently displayed in the cross-section plot region, and displaying in the cross-section calculator region a highlighted representation of the selected data point, and displaying in the cross-section plot region a highlighted representation of the corresponding data point;
in response to the user input, calculating a collisional cross-section of the selected ion and displaying data regarding the calculated collisional cross-section in the cross-section calculator region, and receiving a user selection of a data point currently displayed in the cross-section calculator region or a corresponding data point currently displayed in the cross-section plot region, and modifying the display of one of the ion data plots currently displayed outside cross-section calculator interface based on the data point selected.

20. An ion mobility spectrometry-mass spectrometry (IMS-MS) system comprising: the computing device of claim 1; and an ion detector communicating with the computing device, wherein the IMS-MS system is configured for performing the method of claim 1.
